(19) United States
(12) Patent Application Publication
(10) Pub. No.: US 2024/0386737 A1
(43) Pub. Date: Nov. 21, 2024

(54) DOCUMENT CLASSIFICATION SYSTEM AND DOCUMENT CLASSIFICATION METHOD

(71) Applicant: Semiconductor Energy Laboratory Co., Ltd., Atsugi-shi, Kanagawa-ken (JP)

(72) Inventors: Yoshitaka DOZEN, Atsugi (JP); Kunitaka YAMAMOTO, Atsugi (JP)

(21) Appl. No.: 18/682,496

(22) PCT Filed: Aug. 17, 2022
(86) PCT No.: PCT/IB2022/057693

§ 371 Date: Feb. 9, 2024

(30) Foreign Application Priority Data
Aug. 26, 2021 (JP) 2021-138189

(51) Int. Cl. G06V 30/413; G06V 30/418

(52) U.S. Cl. CPC G06V 30/413; G06V 30/418

(57) ABSTRACT

A document classification system that enables highly accurate document classification is provided. The document classification system includes an input unit, a storage unit, a processing unit, and an output unit. The input unit has a function of receiving document data and reference document data. The storage unit has a function of storing a classification model. The processing unit has a function of creating first classification data to third classification data from the document data and the reference document data. A word contained in the document data and not contained in the reference document data belongs to the first classification data. A word contained in the document data and contained in the reference document data belongs to the second classification data. A word not contained in the document data and contained in the reference document data belongs to the third classification data. The processing unit has a function of creating document comparison data from the first classification data to the third classification data and determining a category of the reference document data using the classification model. The output unit has a function of outputting the category.

### TECHNICAL FIELD

One embodiment of the present invention relates to a document classification system and a document classification method.

Note that one embodiment of the present invention is not limited to the above technical field. Examples of the technical field of one embodiment of the present invention include a semiconductor device, a display device, a light-emitting device, a power storage device, a memory device, an electronic device, a lighting device, an input device (e.g., a touch sensor or the like), an input/output device (e.g., a touch panel or the like), a method for driving any of them, and a method for manufacturing any of them.

### BACKGROUND ART

Patents have gained interest and awareness as intellectual property rights, and technologies to support the effective use of patents are being developed. For example, evaluating the validity of a patent requires comparing the patent with a reference document that may be relevant, and carefully examining whether the patent has validity or not. Similarly, examining an earlier application in patent application requires comparing the application with a reference document that may be relevant, and carefully examining whether or not there is relativity therebetween. When a large number of reference documents are subjected to comparison, it takes an enormous time for careful examination.

Patent Document 1 discloses a system that is capable of retrieving information relevant to input intellectual property information. For example, the system is capable of retrieving patent documents, papers, or industrial products that are similar to a designated patent document.

### REFERENCE

### Patent Document

[Patent Document 1] Japanese Published Patent Application No. 2018-206376

### SUMMARY OF THE INVENTION

### Problems to be Solved by the Invention

An object of one embodiment of the present invention is to provide a document classification system that enables highly accurate document classification. An object of one embodiment of the present invention is to provide a document classification system that enables highly efficient document classification. An object of one embodiment of the present invention is to provide a novel document classification system. An object of one embodiment of the present invention is to provide a document classification method that enables highly accurate document classification. An object of one embodiment of the present invention is to provide a document classification method that enables highly efficient document classification. An object of one embodiment of the present invention is to provide a novel document classification method.

Note that the description of these objects does not preclude the existence of other objects. One embodiment of the present invention does not need to achieve all of these objects. Other objects can be derived from the description of the specification, the drawings, and the claims.

### Means for Solving the Problems

One embodiment of the resent invention is a document classification system including an input unit, a storage unit, a processing unit, and an output unit. The input unit has a function of receiving document data and reference document data. The storage unit has a function of storing a classification model. The processing unit has a function of creating first classification data, second classification data, and third classification data from the document data and the reference document data. A word contained in the document data and not contained in the reference document data belongs to the first classification data. A word contained in the document data and contained in the reference document data belongs to the second classification data. A word not contained in the document data and contained in the reference document data belongs to the third classification data. The processing unit has a function of creating document comparison data from the first classification data, the second classification data, and the third classification data. The processing unit has a function of determining a category of the reference document data from the document comparison data using the classification model. The output unit has a function of outputting the category.

One embodiment of the present invention is a document classification system including an input unit, a storage unit, a processing unit, and an output unit. The input unit has a function of receiving document data. The storage unit has a function of storing reference document data and a classification model. The processing unit has a function of creating first classification data, second classification data, and third classification data from the document data and the reference document data. A word contained in the document data and not contained in the reference document data belongs to the first classification data. A word contained in the document data and contained in the reference document data belongs to the second classification data. A word not contained in the document data and contained in the reference document data belongs to the third classification data. The processing unit has a function of creating document comparison data from the first classification data, the second classification data, and the third classification data. The processing unit has a function of determining a category of the reference document data from the document comparison data using the classification model. The output unit has a function of outputting the category.

In the above document classification system, the processing unit preferably has a function of creating first vector data from the word belonging to the first classification data. The processing unit preferably has a function of creating second vector data from the word belonging to the second classification data. The processing unit preferably has a function of creating third vector data from the word belonging to the third classification data. The processing unit preferably has a function of creating the document comparison data from the first vector data, the second vector data, and the third vector data.

In the above document classification system, the processing unit preferably has a function of creating first vector data from the word belonging to the first classification data and averaging elements of the first vector data to create first average vector data. The processing unit preferably has a function of creating second vector data from the word belonging to the second classification data and averaging elements of the second vector data to create second average vector data. The processing unit preferably has a function of creating third vector data from the word belonging to the third classification data and averaging elements of the third vector data to create third average vector data. The processing unit preferably has a function of creating the document comparison data from the first average vector data, the second average vector data, and the third average vector data.

In the above document classification system, the classification model preferably includes a neural network. The processing unit preferably has a function of training the classification model using first document data, second document data, and a category of the second document with respect to the first document as teacher data.

One embodiment of the present invention is a document classification method, in which document data and reference document data is received; first classification data, second classification data, and third classification data are created from the document data and the reference document data; document comparison data is created from the first classification data, the second classification data, and the third classification data; a category of the reference document data is determined from the document comparison data using a classification model; and the category is output. A word contained in the document data and not contained in the reference document data belongs to the first classification data. A word contained in the document data and contained in the reference document data belongs to the second classification data. A word not contained in the document data and contained in the reference document data belongs to the third classification data.

### Effect of the Invention

According to one embodiment of the present invention, a document classification system that enables highly accurate document classification can be provided. Alternatively, a document classification system that enables highly efficient document classification can be provided. Alternatively, a novel document classification system can be provided. Alternatively, a document classification method that enables highly accurate document classification can be provided. Alternatively, a document classification method that enables highly efficient document classification can be provided. Alternatively, a novel document classification method can be provided.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

FIG. 1 is a diagram showing a structure example of a document classification system.

FIG. 2 is a diagram showing an example of a document classification method.

FIG. 3 is a diagram showing an example of a document classification method.

FIG. 4 is a diagram showing an example of a document classification method.

FIG. 5A to FIG. 5C are diagrams showing an example of a document classification method.

FIG. 6 is a diagram showing an example of a document classification method.

FIG. 7A and FIG. 7B are diagrams showing a structure example of a neural network.

FIG. 8 is a diagram showing a structure example of a neural network.

FIG. 9A and FIG. 9B are diagrams showing an example of a document classification method.

FIG. 10 is a diagram showing an example of a document classification method.

FIG. 11A and FIG. 11B are diagrams showing an example of a document classification method.

FIG. 12A to FIG. 12C are diagrams showing an example of a document classification method.

FIG. 13A to FIG. 13C are diagrams showing an example of a document classification method.

FIG. 14A to FIG. 14D are diagrams showing an example of a document classification method.

FIG. 15A to FIG. 15D are diagrams showing an example of a document classification method.

FIG. 16 is a diagram showing an example of a document classification method.

FIG. 17 is a diagram showing an example of a document classification method.

FIG. 18A to FIG. 18C are diagrams showing examples of a document classification method.

FIG. 19 is a diagram showing an example of a document classification method.

FIG. 20 is a diagram showing an example of a document classification method.

FIG. 21 is a diagram showing an example of a document classification system.

FIG. 22 is a diagram showing an example of a document classification system.

FIG. 23 is a diagram showing the percentages of correct answers in Example.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments.

Note that in structures of the invention described below, the same portions or portions having similar functions are denoted by the same reference numerals in different drawings, and the description thereof is not repeated. Furthermore, the same hatch pattern is used for the portions having similar functions, and the portions are not especially denoted by reference numerals in some cases.

In addition, the position, size, range, or the like of each structure shown in drawings does not represent the actual position, size, range, or the like in some cases for easy understanding. Thus, the disclosed invention is not necessarily limited to the position, size, range, or the like disclosed in the drawings.

### Embodiment 1

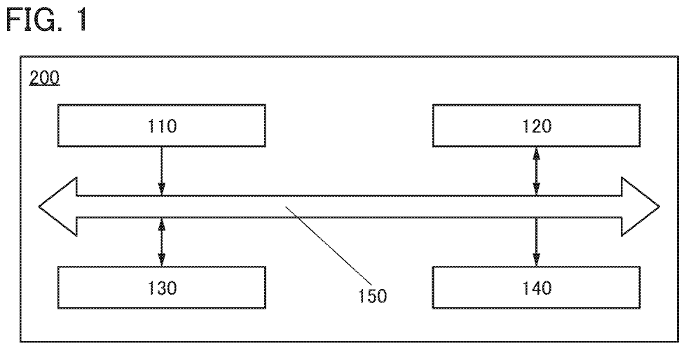

In this embodiment, a document classification system and a document classification method of embodiments of the present invention will be described with reference to FIG. 1 to FIG. 20.

The document classification system of one embodiment of the present invention has a function of comparing two documents and classifying the document with the use of a classification model. The document classification system of one embodiment of the present invention is not limited to specific languages used in documents and is capable of comparing documents that uses one or more of Japanese, English, German, French, Chinese, and Korean, for example. Note that in this specification and the like, a document subjected to comparison with a certain document is sometimes referred to as a reference document in some cases.

### Structure Example 1 of Document Classification System

FIG. 1 shows a block diagram of a document classification system 200. The document classification system 200 includes an input unit 110, a storage unit 120, a processing unit 130, an output unit 140, and a transmission path 150.

### [Input Unit 110]

The input unit 110 has a function of receiving data of a document (hereinafter also referred to as document data) and data of a reference document (hereinafter also referred to as reference document data) from the outside of the document classification system 200. The document data and the reference document data received by (hereinafter also referred to as input to) the input unit 110 are supplied to one or both of the storage unit 120 and the processing unit 130 via the transmission path 150.

### [Storage Unit 120]

The storage unit 120 has a function of storing a program to be executed by the processing unit 130 and a classification model. In addition, the storage unit 120 may have a function of storing calculation results and inference results generated by the processing unit 130, data input to the input unit 110, and the like.

The storage unit 120 includes at least one of a volatile memory and a nonvolatile memory. Examples of the volatile memory include a DRAM (Dynamic Random Access Memory) and an SRAM (Static Random Access Memory). Examples of the nonvolatile memory include an ReRAM (Resistive Random Access Memory, also referred to as a resistance-change memory), a PRAM (Phase-change Random Access Memory), an FeRAM (Ferroelectric Random Access Memory), an MRAM (Magnetoresistive Random Access Memory, also referred to as a magnetoresistive memory), and a flash memory. As a memory used in the storage unit 120, a device using a transistor including an oxide semiconductor (also referred to as an OS transistor) may be used. Examples of the device using an oxide semiconductor include a DOSRAM (registered trademark) and a NOSRAM (registered trademark). A DOSRAM is a memory that uses OS transistors with low off-state current as selection transistors (transistor serving as switching elements) of memory cells. A NOSRAM is a memory that uses OS transistors with low off-state current as selection transistors (transistors serving as switching elements) of memory cells and transistors including a silicon material or the like as output transistors of the memory cells. An OS transistor will be described in detail in Embodiment 2. The storage unit 120 may include a storage media drive. Examples of the recording media drive include a hard disk drive (HDD) and a solid state drive (SSD).

The storage unit 120 may include a database. The database can be configured to contain reference document data, for example.

The document classification system 200 may have a function of extracting data from a database existing outside the system. The document classification system 200 may have a function of extracting data from both of its own database and an external database. The document classification system 200 has a function of extracting reference document data from a database, for example.

One or both of a storage and a file server may be used instead of the database. For example, in the case where a file contained in a file server is used, the database preferably contains the path for the file stored in the file server.

### [Processing Unit 130]

The processing unit 130 has a function of processing the document data and the reference document data supplied from one or both of the input unit 110 and the storage unit 120 and classifying the reference document. Specifically, the processing unit 130 has a function of extracting words from the document data and the reference document data supplied from one or both of the input unit 110 and the storage unit 120 and classifying the reference document using a trained classification model on the basis of data created with the words. In addition, the processing unit 130 has a function of performing processing with the use of various data contained in the database. The processing unit 130 has a function of supplying the classification results to one or both of the storage unit 120 and the output unit 140.

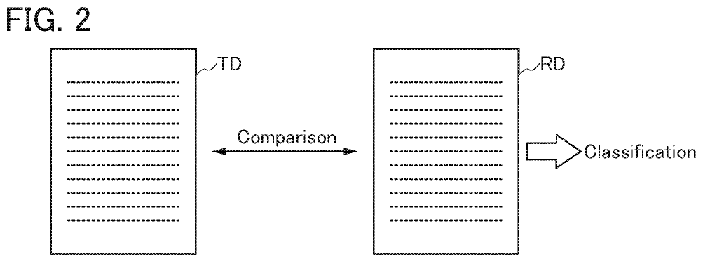

FIG. 2 shows a situation in which a document is classified with the document classification system. FIG. 2 schematically shows a situation in which document data TD and reference document data RD are compared with each other to classify the reference document data RD. The classification can be two-level classification, i.e., classification into two categories, or multilevel classification (also referred to as multi-class classification), i.e., classification into three or more categories. For example, two-level classification can be performed in such a manner that the reference document data RD is classified to be “highly relevant” or “less relevant” to the document data TD.

The processing unit 130 can include an arithmetic circuit, for example. The processing unit 130 can include, for example, a central processing unit (CPU).

The processing unit 130 may include a microprocessor such as a DSP (Digital Signal Processor) or a GPU (Graphics Processing Unit). The microprocessor may be constructed with a PLD (Programmable Logic Device) such as an FPGA (Field Programmable Gate Array) or an FPAA (Field Programmable Analog Array). The processing unit 130 can interpret and execute instructions from programs with the use of a processor to process various kinds of data and control programs. The programs to be executed by the processor are stored in at least one of a memory region of the processor and the storage unit 120.

The processing unit 130 may include a main memory. The main memory includes at least one of a volatile memory such as a RAM (Random Access Memory) and a nonvolatile memory such as a ROM (Read Only Memory).

For example, a DRAM or SRAM is used as the RAM, a virtual memory space is assigned in the RAM and utilized as a working space of the processing unit 130. An operating system, an application program, a program module, program data, a look-up table, and the like that are stored in the storage unit 120 are loaded into the RAM for execution. The data, program, and program module that are loaded into the RAM are each directly accessed and operated by the processing unit 130.

In the ROM, a BIOS (Basic Input/Output System), firmware, and the like for which rewriting is not needed can be stored. Examples of the ROM include a mask ROM, an OTPROM (One Time Programmable Read Only Memory), and an EPROM (Erasable Programmable Read Only Memory). Examples of the EPROM include a UV-EPROM (Ultra-Violet Erasable Programmable Read Only Memory), which can erase stored data by ultraviolet irradiation, an EEPROM (Electrically Erasable Programmable Read Only Memory), and a flash memory.

It is preferable to use artificial intelligence (AI) for at least part of processing of the document classification system.

It is particularly preferable to use an artificial neural network (ANN; hereinafter just referred to as neural network) for the document classification system. The neural network is obtained with a circuit (hardware) or a program (software).

In this specification and the like, a neural network refers to a general model that is modeled on a biological neural network, determines the connection strength of neurons by learning, and has the capability of solving problems. A neural network includes an input layer, a middle layer (also referred to as a hidden layer), and an output layer.

In the description of the neural network in this specification and the like, to determine a connection strength of neurons (also referred to as a weight coefficient) from the existing information is referred to as “learning” in some cases.

In this specification and the like, to draw a new conclusion from a neural network formed with the connection strength obtained by learning is referred to as “inference” in some cases.

A neural network is preferably used for the classification model. In particular, deep learning is preferably used for the classification model. For example, a convolutional neutral network (CNN), a recurrent neural network (RNN), a long short term memory (LSTM), a fully connected neural network (FCNN), an autoencoder (AE), a variational autoencoder (VAE), a support vector machine, or generative adversarial networks (GAN) can be used for the deep learning.

Machine learning (ML) may be used for the classification model. Supervised machine learning can be suitably used for the classification model. Example of the machine leaning that can be used include a support vector machine, random forest, gradient boosting, logistics regression, and clustering.

### [Output Unit 140]

The output unit 140 outputs information on the basis of a processing result of the processing unit 130. For example, the output unit 140 can output one or both of a calculation result and an inference result in the processing unit 130 to the outside of the document classification system 200. Specifically, the output unit 140 can output the category determined in the processing unit 130 to the outside. Furthermore, the output unit 140 can output various kinds of data contained in a database on the basis of a processing result of the processing unit 130.

### [Transmission Path 150]

The transmission path 150 has a function of transmitting data. Data transmission and reception among the input unit 110, the storage unit 120, the processing unit 130, and the output unit 140 can be performed via the transmission path 150.

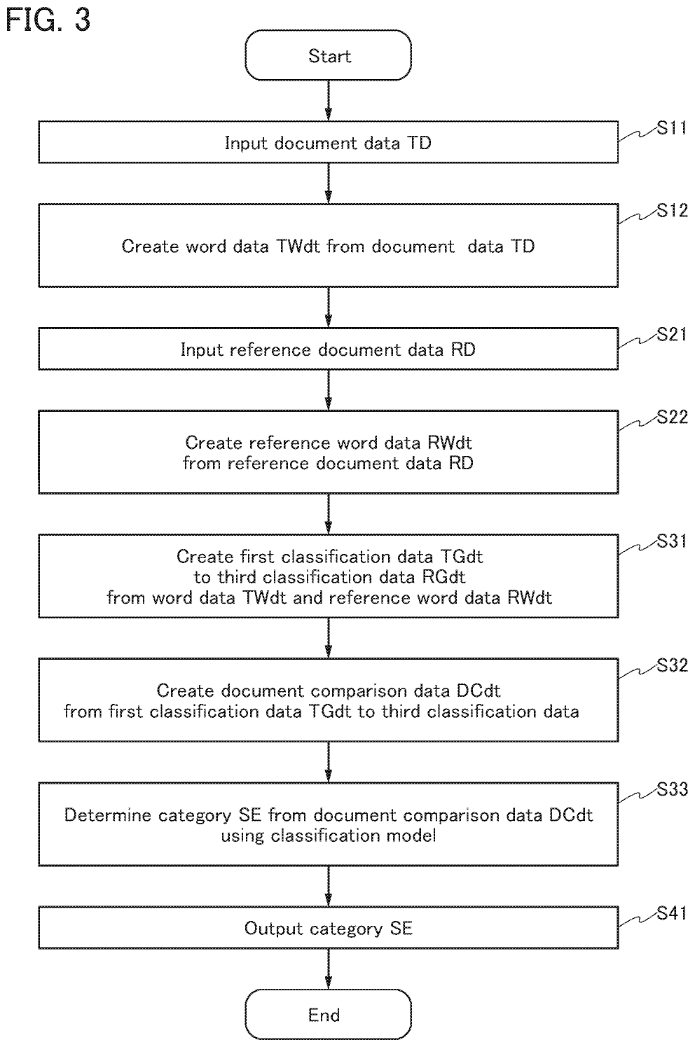

A document classification method using the document classification system of one embodiment of the present invention is described with reference to FIG. 3 to FIG. 20.

### Example 1-1 of Document Classification Method

FIG. 3 shows a flowchart of an example of the document classification method using the document classification system.

### [Step S11]

First, the user inputs the document data TD to the input unit 110 (Step S11 in FIG. 3).

For example, a document of a patent for which the user wants to evaluate validity or a patent document that is owned by the user and has not yet been filed or published can be used as the document data TD.

### [Step S12]

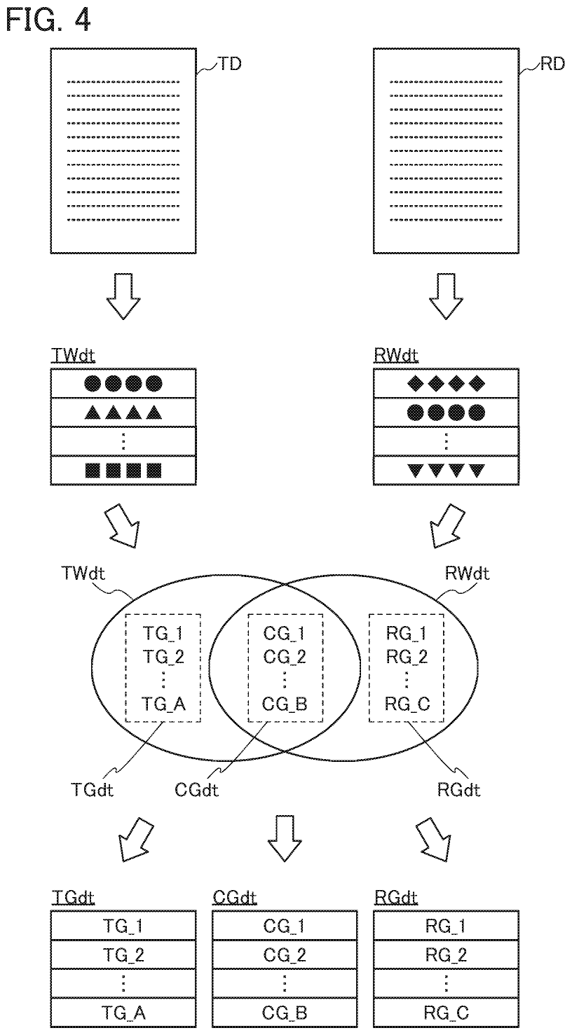

Next, the processing unit 130 extracts words from the document data TD input in Step S11 and creates data of the words contained in the document data TD (hereinafter referred to as word data TWdt) (Step S12 in FIG. 3). FIG. 4 schematically shows the word data TWdt extracted from the document data TD.

The word extraction from the document data TD can employ a morphological analysis, N-gram (also referred to as an N text index method or an N-gram method), or Sentencepiece, for example.

In morphological analysis, text is divided into morphemes (smallest meaningful units in a language), and the part of speech or the like of each of the morphemes can be determined. Morphological analysis can be suitably used for languages in which no space is interposed between words, such as Japanese. The word data TWdt may be created by extracting only words with specific part of speech with the use of morphological analysis. For example, the word data TWdt can be created by extracting only nouns. For another example, the word data TWdt can be created by extracting only nouns and verbs. Also in the case of languages in which a space is interposed between words, i.e., what is called “leaving space between words” is performed, such as English, the word data TWdt can be created by performing morphological analysis and extracting only words with specific part of speech.

Note that the range of the document data TD from which words are extracted may be limited. For example, in the case where the document data TD is a patent document, a structure may be employed in which the range from which words are extracted is set to a specification, and no word is extracted from the scope of claims and the abstract. In addition, in the case where the document data TD is a patent document, information on patent classification may be extracted from the document data TD. The use of the information on patent classification data makes it possible to perform classification in consideration of the technical field of the document data TD. As the patent classification, one or more of IPC (International Patent Classification), CPC (Cooperative Patent Classification), and UPC (United States Patent Classification) can be used, for example.

The words extracted from the document data TD may be converted using a concept dictionary, and the converted words may be used as the word data TWdt. The concept dictionary is a list to which the categories of words, relations with other words, and the like are added. The concept dictionary may be an existing concept dictionary. Alternatively, the user may create a concept dictionary tailored to the field of a document. Further alternatively, the user may add words that are often used in the field of a document to a general-purpose concept dictionary. The use of the concept dictionary makes it possible to perform classification with high accuracy even on documents where the same concept is described with different words. The concept dictionary can be stored in the storage unit 120 as a database. Alternatively, the concept dictionary may be stored in a database existing outside the document classification system 200.

The words extracted from the document data TD may be translated into words of another language using a translation dictionary, and the translated words may be used as the word data TWdt. The translation dictionary may be an existing translation dictionary. Alternatively, a translation dictionary tailored to the field of a document may be created to be used. Further alternatively, words that are often used in the field of a document may be added to a general-purpose translation dictionary to be used. The use of the translation dictionary makes it possible to perform classification even on documents described in different languages. The translation dictionary can be stored in the storage unit 120 as a database. Alternatively, the translation dictionary may be stored in a database existing outside the document classification system 200.

The word data TWdt may be arranged in the order of the appearance frequency of words, for example. The arrangement order of the word data TWdt is not particularly limited; for example, the word data TWdt may be arranged in the order in which words appear in the document data TD.

### [Step S21]

Next, the user inputs the reference document data RD to be compared with the document data TD, to the input unit 110 (Step S21 in FIG. 3). Note that although the reference document data RD is input after Step S12 in the example shown in FIG. 3, one embodiment of the present invention is not limited thereto. The reference document data RD may be input in Step S11.

The reference document data RD is a document to be subjected to comparison with the document data TD and can be a technical document, for example. Examples of the technical document that can be used include publications issued in all countries of the world, such as patent documents and papers.

### [Step S22]

Next, the processing unit 130 extracts words from the reference document data RD input in Step S21 and creates data of the words contained in the reference document data RD (hereinafter referred to as reference word data RWdt) (Step S22 in FIG. 3). FIG. 4 schematically shows the reference word data RWdt extracted from the reference document data RD.

Note that the range of the reference document data RD from which words are extracted may be limited. For example, in the case where the reference document data RD is a patent document, a structure may be employed in which the range from which words are extracted is set to a specification, and no word is extracted from the scope of claims and the abstract. In addition, in the case where the reference document data RD is a patent document, information on patent classification may be extracted from the reference document data RD. The use of the information on patent classification data makes it possible to perform classification in consideration of the technical field of the reference document data RD.

The words extracted from the reference document data RD may be converted using a concept dictionary, and the converted words may be used as the reference word data RWdt. The words extracted from the reference document data RD may be translated into words of another language using a translation dictionary, and the translated words may be used as the reference word data RWdt. The reference word data RWdt may be arranged in the order of the appearance frequency of words, for example. The arrangement order of the reference word data RWdt is not particularly limited; for example, the reference word data RWdt may be arranged in the order in which words appear in the reference document data RD.

The above description of Step S12 can be referred to for a method for extracting words from the reference document data RD; thus, the detailed description thereof is omitted.

### [Step S31]

Next, the processing unit 130 compares the word data TWdt with the reference word data RWdt to create first classification data TGdt, second classification data CGdt, and third classification data RGdt (Step S31 in FIG. 3).

Words that are contained in the word data TWdt but not contained in the reference word data RWdt belong to the first classification data TGdt. That is, words that are contained in the document data TD but not contained in the reference document data RD belong to the first classification data TGdt. As shown in FIG. 4, the first classification data TGdt corresponds to the words contained in a difference set obtained by removing the set of words contained in the reference word data RWdt from the set of words contained in the word data TWdt. In FIG. 4, A words, a word TG_1 to a word TG_A, are shown as the first classification data TGdt. It can also be said that the word TG_1 to the word TG_A corresponding to the first classification data TGdt represent features of the document data TD with respect to the reference document data RD.

Words that are contained in the word data TWdt and are also contained in the reference word data RWdt belong to the second classification data CGdt. That is, words that are contained in the document data TD and are also contained in the reference document data RD belong to the second classification data CGdt. As shown in FIG. 4, the second classification data CGdt corresponds to the words contained in the intersection (also referred to as the crossing or product set) of the set of words contained in the word data TWdt and the set of words contained in the reference word data RWdt. In FIG. 4, B words, a word CG_1 to a word CG_B, are shown as the second classification data CGdt. It can also be said that the word CG_1 to the word CG_B corresponding to the second classification data CGdt represent features common to the document data TD and the reference document data RD.

Words that are not contained in the word data TWdt but are contained in the reference word data RWdt belong to the third classification data RGdt. That is, words that are not contained in the document data TD but are contained in the reference document data RD belong to the third classification data RGdt. As shown in FIG. 4, the third classification data RGdt corresponds to the words contained in the difference set obtained by removing the set of words contained in the word data TWdt from the set of words contained in the reference word data RWdt. In FIG. 4, C words, a word RG_1 to a word RG_C, are shown as the third classification data RGdt. It can also be said that the word RG_1 to the word RG_C corresponding to the third classification data RGdt represent features of the reference document data RD with respect to the document data TD.

A, the number of words contained in the first classification data TGdt, B, the number of words contained in the second classification data CGdt, and C, the number of words contained in the third classification data RGdt are each independently an integer of 1 or more.

### [Step S32]

Next, the word TG_1 to the word TG_A contained in the first classification data TGdt created in Step S31 are each vectorized to create first vector data TVdt. Similarly, the word CG_1 to the word CG_B contained in the second classification data CGdt are each vectorized to create second vector data CVdt. The word RG_1 to the word RG_C contained in the third classification data RGdt are each vectorized to create third vector data RVdt.

For the vectorization of words, for example, Word2vec, BoW (Bag of Words), or BERT (Bidirectional Encoder Representations from Transformers), which are open-sourced algorithms, can be used. In one embodiment of the present invention, the method for vectorizing words is not particularly limited.

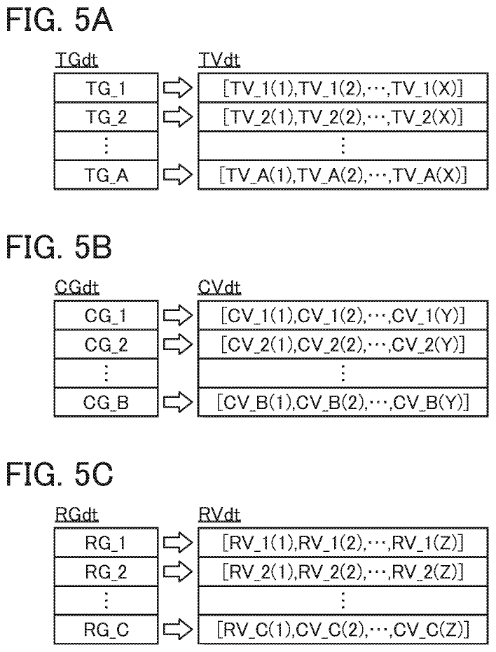

FIG. 5A shows an example of the first vector data TVdt created from the first classification data TGdt. From the word TG_1 contained in the first classification data TGdt, a vector [TV_1(1), TV_1(2), . . . , TV_1(X)] is created. In the example shown here, the word TG_1 is converted into an X-dimensional vector including the element TV_1(1) to the element TV_1(X). Note that the element TV_1(1) to the element TV_1(X) are each independently a real number. Similarly, each of pieces of data of the other words contained in the first classification data TGdt is converted into an X-dimensional vector. The first vector data TVdt contains A X-dimensional vectors.

FIG. 5B shows an example of the second vector data CVdt created from the second classification data CGdt. From the word CG_1 contained in the second classification data CGdt, a vector [CV_1(1), CV_1(2), . . . , CV_1(Y)] is created. In the example shown here, the word CG_1 is converted into a Y-dimensional vector including the element CV_1(1) to the element CV_1(Y). Note that the element CV_1(1) to the element CV_1(Y) are each independently a real number. Similarly, each of pieces of data of the other words contained in the second classification data CGdt is converted into a Y-dimensional vector. The second vector data CVdt contains B Y-dimensional vectors.

FIG. 5C shows an example of the third vector data RVdt created from the third classification data RGdt. From the word RG_1 contained in the third classification data RGdt, a vector [RV_1(1), RV_1(2), . . . , RV_1(Z)] is created. In the example shown here, the word RG_1 is converted into a Z-dimensional vector including the element RV_1(1) to the element RV_1(Z). Note that the element RV_1(1) to the element RV_1(Z) are each independently a real number. Similarly, each of pieces of data of the other words contained in the third classification data RGdt is converted into a Z-dimensional vector. The third vector data RVdt contains C Z-dimensional vectors.

Each of the first vector data TVdt, the second vector data CVdt, and the third vector data RVdt includes vectors converted from words. Such vectors created by conversion of words can be referred to as word vectors.

The dimension number X of the first vector data TVdt, the dimension number Y of the second vector data CVdt, and the dimension number Z of the third vector data RVdt are each independently an integer of 1 or more.

When the dimension number X, the dimension number Y, and the dimension number Z are small, the accuracy of classification by the classification model is sometimes low. When the dimension number X, the dimension number Y, and the dimension number Z are large, the amount of calculation is large, and the time required for the processing is increased in some cases. It is preferable that the dimension number X, the dimension number Y, and the dimension number Z be each independently greater than or equal to 1 and less than or equal to 10000, further preferably greater than or equal to 100 and less than or equal to 5000, still further preferably greater than or equal to 200 and less than or equal to 2000, yet still further preferably greater than or equal to 200 and less than or equal to 1000. When the dimension number X, the dimension number Y, and the dimension number Z are within the above range, both high-accuracy classification and high-speed processing can be achieved. Note that the dimension number X, the dimension number Y, and the dimension number Z may be the same as or different from one another.

The dimension number X, the dimension number Y, and the dimension number Z may be set freely by the user. When the user sets the dimension number X, the dimension number Y, and the dimension number Z, the classification model is trained with the set dimension numbers.

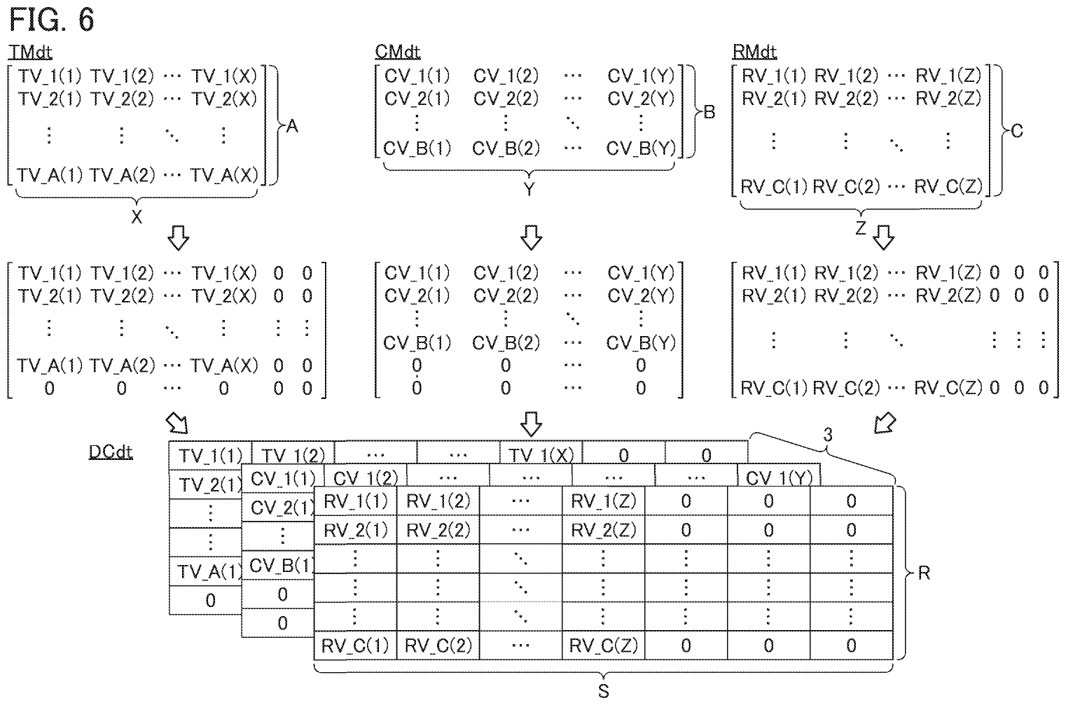

Next, document comparison data DCdt is created from the first vector data TVdt, the second vector data CVdt, and the third vector data RVdt. FIG. 6 shows an example where the document comparison data DCdt is in a tensor form of R×S×3. It can be said that the matrix of R rows and S columns of the document comparison data DCdt has three levels.

The first vector data TVdt includes A X-dimensional vectors. As shown in FIG. 6, a matrix TMdt of A rows and X columns can be created from the elements contained in the first vector data TVdt. The second vector data CVdt includes B Y-dimensional vectors. A matrix CMdt of B rows and Y columns can be created from the elements contained in the second vector data CVdt. The third vector data RVdt includes C Z-dimensional vectors. A matrix RMdt of C rows and Z columns can be created from the elements contained in the third vector data RVdt.

Here, the number A, the number B, and the number C are different from one another in some cases; therefore, the row directions of the matrix TMdt, the matrix CMdt, and the matrix RMdt are extended, so that the number of rows is set to R. The number of rows R is an integer greater than or equal to the largest number among the number A, the number B, and the number C. Similarly, when the dimension number X, the dimension number Y, and the dimension number Z are different from one another, the column directions of the matrix TMdt, the matrix CMdt, and the matrix RMdt are extended, so that the number of columns is set to S. The number of rows S is an integer greater than or equal to the largest number among the dimension number X, the dimension number Y, and the dimension number Z. That is, the matrix TMdt, the matrix CMdt, and the matrix RMdt are each extended to a matrix of R rows and S columns. Furthermore, zero is put in the extended region of each matrix. Then, the matrix TMdt, the matrix CMdt, and the matrix RMdt that are extended are put together, whereby the document comparison data DCdt in a tensor form of R×S×3 can be created.

Since the document comparison data DCdt contains information on the words contained only in the document data TD, the words contained in both the document data TD and the reference document data RD, and the words contained only in the reference document data RD, the document comparison data DCdt can be regarded as data indicating the relation between the document data TD and the reference document data RD.

### [Step S33]

Next, a category SE of the reference document data RD is determined from the document comparison data DCdt created in Step S32 using the classification model (Step S33 in FIG. 3).

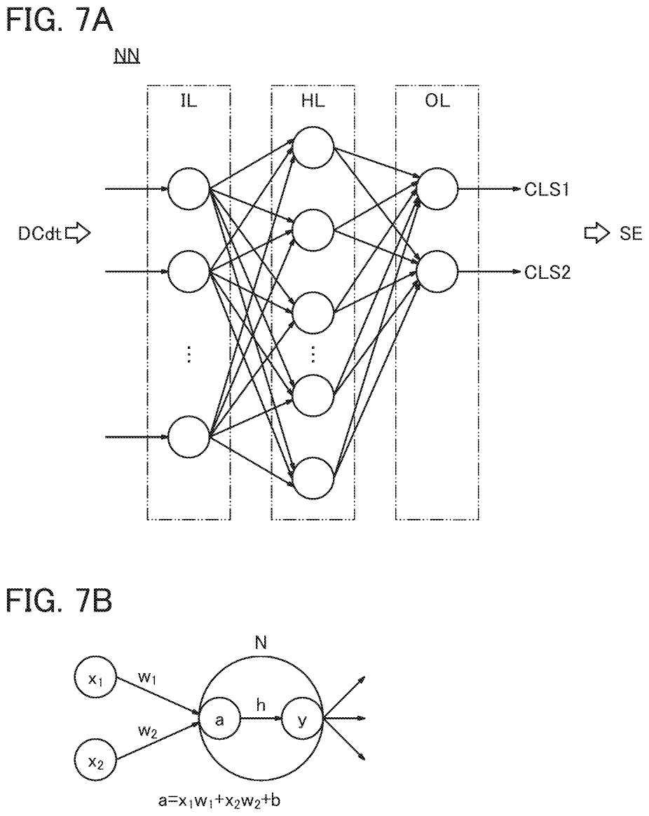

A neural network is preferably used for the classification model. The neural network can be formed of an input layer, a middle layer (hidden layer), and an output layer. FIG. 7A shows a structure example of the neural network. In a neural network NN shown in FIG. 7A, an input layer IL, a middle layer HL, and an output layer OL each include one or more neurons (units). Although the neural network NN includes one middle layer HL in the structure shown in FIG. 7A, the neural network NN may include a plurality of middle layers HL. A neural network including two or more middle layers HL can also be referred to as a DNN (deep neural network), and learning using a deep neural network can also be referred to as deep learning.

Input data is input to neurons in the input layer IL, output signals of neurons in the previous layer or the subsequent layer are input to neurons in the middle layer HL, and output signals of neurons in the previous layer are input to neurons in the output layer OL. Note that each neuron may be connected to all the neurons in the previous and subsequent layers (full connection), or may be connected to some of the neurons.

FIG. 7B shows an example of calculation with the neurons. Here, a neuron N and two neurons in the previous layer which output signals to the neuron N are shown. An output x₁ of a neuron in the previous layer and an output x₂ of a neuron in the previous layer are input to the neuron N. Then, in the neuron N, a total sum x₁w₁+x₂w₂ of a multiplication result (x₁w₁) of the output x₁ and a weight w₁ and a multiplication result (x₂w₂) of the output x₂ and a weight w₂ is calculated, and then a bias b is added as necessary, so that the value a=x₁w₁+x₂w₂+b is obtained. Subsequently, the value a is converted with an activation function h, and an output signal y=h(a) is output from the neuron N. As the activation function, a step function, a ramp function (ReLU function), a sigmoid function, a tanh function, or a softmax function can be used, for example.

The calculation with the neurons includes the calculation that sums the products of the outputs and the weights of the neurons in the previous layer, that is, the product-sum operation (x₁w₁+x₂w₂ described above). This product-sum operation may be performed using a program on software or may be performed using hardware. In the case where the product-sum operation is performed using hardware, a product-sum operation circuit can be used. Either a digital circuit or an analog circuit can be used as this product-sum operation circuit. In the case where an analog circuit is used as the product-sum operation circuit, the circuit scale of the product-sum operation circuit can be reduced, or higher processing speed and lower power consumption can be achieved by reduced frequency of access to a memory.

The product-sum operation circuit may be formed using a transistor including silicon (such as single crystal silicon) in a channel formation region (also referred to as a Si transistor) or may be formed using a transistor including an oxide semiconductor, which is a kind of metal oxide, in a channel formation region (also referred to as an OS transistor). An OS transistor is particularly suitable for a transistor included in a memory of the product-sum operation circuit because of its extremely low off-state current. Note that the product-sum operation circuit may be formed using both a Si transistor and an OS transistor.

As shown in FIG. 7A, the document comparison data DCdt is input as input data to the input layer IL. The number of neurons (units) of the input layer IL can be the number of elements of the document comparison data DCdt. In the case of the document comparison data DCdt shown in FIG. 6, the number of neurons (units) of the input layer IL can be R×S×3.

The number of neurons (units) of the output layer OL can be the number of categories in classification. The output layer OL outputs the probability of each category. The neural network NN outputs a category with the highest probability as a result. In the case of two-level classification, the number of units of the output layer can be two. As the activation function, a sigmoid function can be used, for example. FIG. 7A shows an example of classification into two categories, i.e., first category CLS1 and second category CLS2. The probability of the first category CLS1 and the probability of the second category CLS2 are output from the output layer OL. For example, the first category CLS1 can be “the reference document data RD is highly relevant to the document data TD”, and the second category CLS2 can be “the reference document data RD is less relevant to the document data TD”. Note that in the case of the two-level classification, when the total probability is 1 and the probability of one of two categories is p (p is a real number greater than or equal to 0 and less than or equal to 1), the probability of the other category is determined as 1−p, and thus the number of neurons (units) of the output layer OL may be 1.

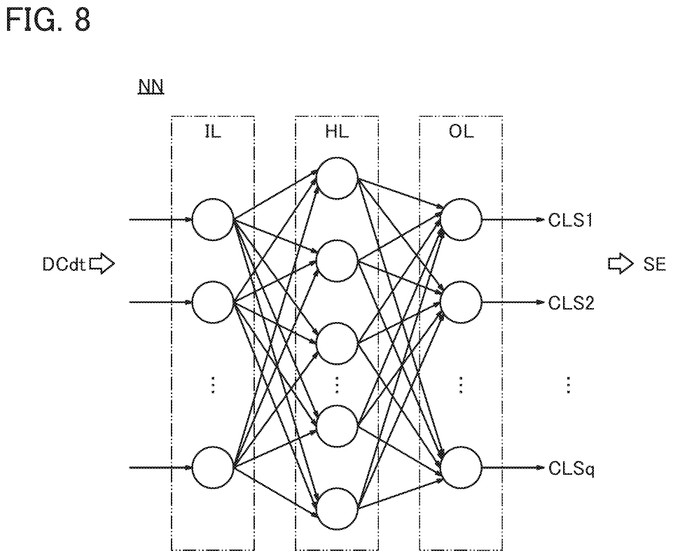

Although two-level classification is performed with a neural network in the example shown in FIG. 7A, one embodiment of the present invention is not limited thereto. As shown in FIG. 8, multilevel classification (multi-class classification), classification into three or more categories, may be used. FIG. 8 shows an example where the number of neurons (units) of the output layer OL is q (q is an integer of 3 or more), and classification into q categories, the first category CLS1 to the q-th category CLSq, is performed. As the activation function, a softmax function can be used, for example. For example, when q is 3, the first category CLS1 can be “the reference document data RD is highly relevant to the document data TD”, the second category CLS2 can be “the reference document data RD is somewhat relevant to the document data TD”, and the third classification CLS3 can be “the reference document data RD is less relevant to the document data TD”.

### [Step S41]

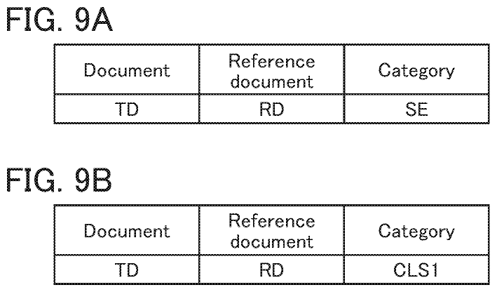

Next, the category SE determined in Step S33 is output to the output unit 140 (Step S41 in FIG. 3). FIG. 9A and FIG. 9B show examples of the output. As shown in FIG. 9A, the output can be a list of the name of the document, the name of the reference document, and the category SE, for example. FIG. 9B shows an example where the second category CLS2 is displayed as the category with the highest probability.

As described above, the use of the document classification method of one embodiment of the present invention enables comparison between two documents and document classification with high accuracy.

For example, in the case of evaluating the validity of the document data TD, the use of the document classification method of one embodiment of the present invention enables classification of the reference document data RD with two levels, “highly relevant” or “less relevant” with respect to the document data TD. As a result, when the reference document data RD is classified to be “highly relevant” to the document data TD, the user examines the descriptions of the document data TD and the reference document data RD carefully; when the reference document data RD is classified to be “less relevant” to the document data TD, the user does not make a careful examination or lowers the priority of the work, enabling efficient evaluation of the validity.

### Example of Learning Method of Classification Model

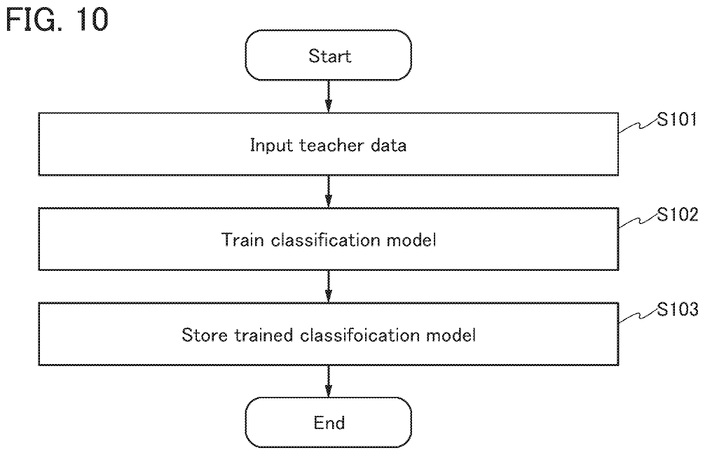

A learning method of the classification model is described. FIG. 10 shows a flowchart of an example of the learning method of the classification model.

Here, a method in which the user trains the classification model is described as an example. When the user trains the classification model, the learning with user's documents, that is, document data that can be subjected to evaluation is possible. The learning enables the classification model to be capable of highly accurate classification. Note that when a classification model trained in advance is provided in the document classification system 200, the user can use the document classification system 200 without training the classification model. In addition, the user may further train the classification model provided in advance in the document classification system 200.

### [Step S101]

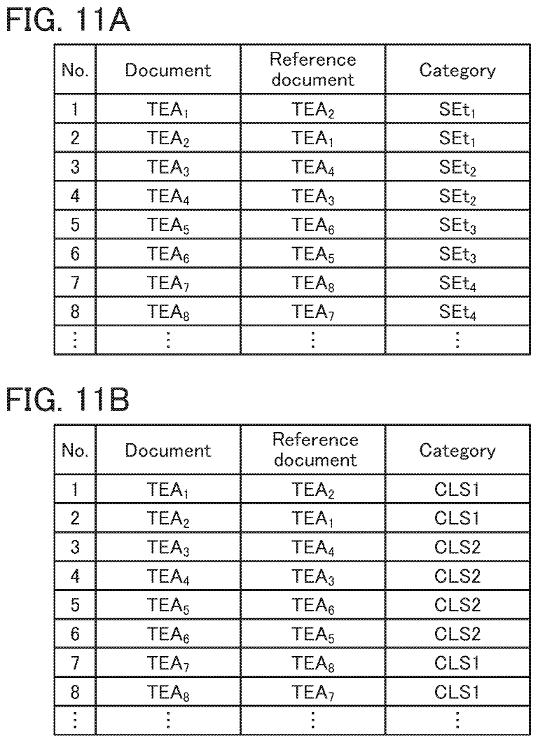

First, the user inputs teacher data to the input unit 110 (Step S101 in FIG. 10). FIG. 11A shows the structure of the teacher data. The teacher data corresponds to data in which document data, reference document data, and the category form a set. The category of the teacher data is determined by the user and corresponds to the category of the reference document data with respect to the document data. For example, in the case of two-level classification, the number of categories of the teacher data is two. A plurality of sets of teacher data are preferably used; as the number of pieces of teacher data is increased, the accuracy can be improved.

As shown in FIG. 11A, a document and a reference document that form a set can be interchanged. For example, a set of a document TEA₁, a reference document TEA₂, and a category SEt₁ can be changed to a set of a document TEA₂, a reference document TEA₁, and the category SEt₁. Similarly, a set of a document TEA₃, a reference document TEA₄, and a category SEt₂ can be changed to a set of a document TEA₄, a reference document TEA₃, and the category SEt₂. In this manner, interchanging a document and a reference document that form a set can increase the number of pieces of teacher data and improve the classification accuracy.

FIG. 11B shows an example of the teacher data. FIG. 11B shows an example of two-level classification, and the number of categories of the teacher data is two: the category CLS1 and the category CLS2.

### [Step S102]

Next, the classification model is trained using the teacher data input in Step S101 (Step S102 in FIG. 10).

For the learning, the document comparison data DCdt is created from the document data and the reference document data and the classification model is trained so that the document comparison data DCdt can be in the category given for the teacher data.

The description of Step S11 to Step S33 in <Example 1-1 of document classification method> can be referred to for a method for creating the document comparison data DCdt from the document data and the reference document data; thus, the detailed description thereof is omitted. Note that the dimension number X of the first vector data TVdt in learning is the same as the dimension number X of the first vector data TVdt in classification. Similarly, the dimension number Y of the second vector data CVdt in learning is the same as the dimension number Y of the second vector data CVdt in classification. The dimension number Z of the third vector data RVdt in learning is the same as the dimension number Z of the third vector data RVdt in the classification.

### [Step S103]

Next, the classification model trained in Step S102 is stored in the storage unit 120 (Step S103 in FIG. 10).

Note that the classification model may be stored in a storage medium connected to the document classification system.

The above is the example of the leaning method of the classification model. Training the classification model can improve the classification accuracy.

### Example 1-2 of Document Classification Method

A document classification method different from the above-described one is described. FIG. 3 can be referred to for a flowchart of the document classification method. Here, a different method for creating the document comparison data DCdt in Step S32 is described.

### [Step S11, Step S12, Step S21, Step S22, and Step S31]

Step S11, Step S12, Step S21, Step S22, and Step S31 are performed in the same manner as in <Example 1-1 of document classification method> described above. The above description can be referred to for Step S11, Step S12, Step S21, Step S22, and Step S31; thus, the detailed description thereof is omitted.

### [Step S32]

Next, the word TG_1 to the word TG_A contained in the first classification data TGdt created in Step S31 are each vectorized to form the first vector data TVdt (see FIG. 5A). Similarly, the word CG_1 to the word CG_B contained in the second classification data CGdt are each vectorized to form the second vector data CVdt (see FIG. 5B). The word RG_1 to the word RG_C contained in the third classification data RGdt are each vectorized to form the third vector data RVdt (see FIG. 5C). The above description can be referred to for the creation of the first vector data TVdt, the second vector data CVdt, and the third vector data RVdt; thus, the detailed description thereof is omitted.

Next, a first average vector TVA, a second average vector CVA, and a third average vector RVA are created from the vectors contained in the first vector data TVdt, the vectors contained in the second vector data CVdt, and the vectors contained in the third vector data RVdt.

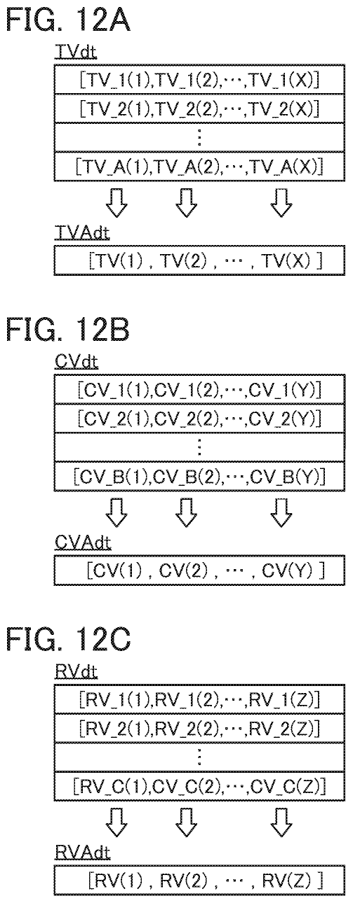

FIG. 12A shows an example of the first average vector TVA created from the vectors contained in the first vector data TVdt. The average values of the elements of the vectors contained in the first vector data TVdt can be used as elements of the first average vector TVA[TV(1), TV(2), . . . , TV(X)]. Specifically, as shown in the following formula, the average value of the element TV_1(1) to the element TV_A(1) in the first dimensions of the vectors contained in the first vector data TVdt can be used as an element TV(1) of the first dimension of the first average vector TVA. An element TV(2) of the second dimension and the other elements of the subsequent dimensions of the first average vector TVA can be calculated in the same manner.

$$TV ( 1 ) = \frac{1}{A} {\sum }_{i = 1}^{A} TV\_i ( 1 ) \qquad [ Formula 1 ]$$

$$TV ( 2 ) = \frac{1}{A} {\sum }_{i = 1}^{A} TV\_i ( 2 )$$

$$TV ( X ) = \frac{1}{A} {\sum }_{i = 1}^{A} TV\_i ( X )$$

The dimension number of the first average vector TVA[TV(1), TV(2), . . . , TV(X)] is X, which is the same as that of the vector contained in the first vector data TVdt. First average vector data TVAdt contains one X-dimensional vector (the first average vector TVA). The first average vector TVA can be referred to as a vector that represents features of words that are contained in the document data TD but not contained in the reference document data RD.

FIG. 12B shows an example of the second average vector CVA created from the vector contained in the second vector data CVdt. The average values of the elements of the vectors contained in the second vector data CVdt can be used as elements of the second average vector CVA[CV(1), CV(2), . . . , CV(Y)]. Specifically, as shown in the following formula, the average value of the element CV_1(1) to the element CV_B(1) in the first dimensions of the vectors contained in the second vector data CVdt can be used as an element CV(1) of the first dimension of the second average vector CVA. An element CV(2) of the second dimension and the other elements of the subsequent dimensions of the second average vector CVA can be calculated in the same manner.

$$CV ( 1 ) = \frac{1}{B} {\sum }_{i = 1}^{B} CV\_i ( 1 ) \qquad [ Formula 2 ]$$

$$CV ( 2 ) = \frac{1}{B} {\sum }_{i = 1}^{B} CV\_i ( 2 )$$

$$CV ( Y ) = \frac{1}{B} {\sum }_{i = 1}^{B} CV\_i ( Y )$$

The dimension number of the second average vector CVA[CV(1), CV(2), . . . , CV(Y)] is Y, which is the same as that of the vector contained in the second vector data CVdt. Second average vector data CVAdt contains one Y-dimensional vector (the second average vector CVA). The second average vector CVA can be referred to as a vector that represents features of words that are contained in the document data TD and contained in the reference document data RD.

FIG. 12C shows an example of the third average vector RVA created from the vectors contained in the third vector data RVdt. The average values of the elements of the vectors contained in the third vector data RVdt can be used as elements of the third average vector RVA[RV(1), RV(2), . . . , RV(Z)]. Specifically, as shown in the following formula, the average value of the element RV_1(1) to the element RV_C(1) in the first dimensions of the vectors contained in the third vector data RVdt can be used as an element RV(1) of the first dimension of the third average vector RVA. An element RV(2) of the second dimension and the other elements of the subsequent dimensions of the third average vector RVA can be calculated in the same manner.

$$RV ( 1 ) = \frac{1}{C} {\sum }_{i = 1}^{C} RV\_i ( 1 ) \qquad [ Formula 3 ]$$

$$RV ( 2 ) = \frac{1}{C} {\sum }_{i = 1}^{C} RV\_i ( 2 )$$

$$RV ( Z ) = \frac{1}{C} {\sum }_{i = 1}^{C} RV\_i ( Z )$$

The dimension number of the third average vector RVA[RV(1), RV(2), . . . , RV(Z)] is Z, which is the same as that of the vector contained in the third vector data RVdt. Third average vector data RVAdt contains one Z-dimensional vector (the third average vector RVA). The third average vector RVA can be referred to as a vector that represents features of words that are not contained in the document data TD but are contained in the reference document data RD.

Although the average value of the elements of each vector is used in the example described here, one embodiment of the present invention is not limited thereto. As shown in the following formula, the total value of the elements of each vector may be used.

$$TV ( 1 ) = {\sum }_{i = 1}^{A} TV\_i ( 1 ) \qquad [ Formula 4 ]$$

$$TV ( 2 ) = {\sum }_{i = 1}^{A} TV\_i ( 2 )$$

$$TV ( X ) = {\sum }_{i = 1}^{A} TV\_i ( X )$$

$$CV ( 1 ) = {\sum }_{i = 1}^{B} CV\_i ( 1 ) \qquad [ Formula 5 ]$$

$$CV ( 2 ) = {\sum }_{i = 1}^{B} CV\_i ( 2 )$$

$$CV ( Y ) = {\sum }_{i = 1}^{B} CV\_i ( Y )$$

$$RV ( 1 ) = {\sum }_{i = 1}^{C} RV\_i ( 1 ) \qquad [ Formula 6 ]$$

$$RV ( 2 ) = {\sum }_{i = 1}^{C} RV\_i ( 2 )$$

$$RV ( Z ) = {\sum }_{i = 1}^{C} RV\_i ( Z )$$

Note that the first average vector TVA[TV(1), TV(2), . . . , TV(X)], the second average vector CVA[CV(1), CV(2), . . . , CV(Y)], and the third average vector RVA[RV(1), RV(2), . . . , RV(Z)] may be extended, and information on patent classification may be added to the extended region. The extended dimension number can be an integer of 1 or more and can be a fixed value. An element corresponding to patent classification that is contained in the document data TD but not contained in the reference document data RD can be put in the extended region of the first average vector TVA. An element corresponding to patent classification that is contained in the document data TD and also contained in the reference document data RD can be put in the extended region of the second average vector CVA. An element corresponding to patent classification that is not contained in the document data TD but is contained in the reference document data RD can be put in the extended region of the third average vector RVA. In the case where the document data TD and the reference document data RD are not patent documents, zero is put in the extended region of each of the first average vector TVA, the second average vector CVA, and the third average vector RVA. In the case where the document data TD is a patent document and the reference document data RD is not a patent document, zero is put in the extended region of each of the second average vector CVA and the third average vector RVA. In the case where the document data TD is not a patent document and the reference document data RD is a patent document, zero is put in the extended region of each of the first average vector TVA and the second average vector CVA.

Next, document comparison data DCdt is created from the first average vector TVA, the second average vector CVA, and the third average vector RVA.

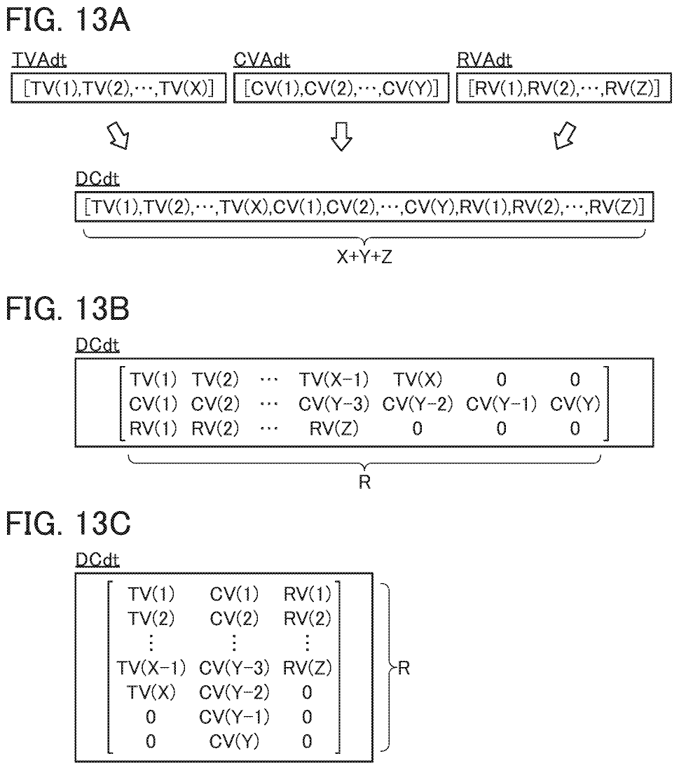

FIG. 13A shows an example of the document comparison data DCdt created from the first average vector TVA, the second average vector CVA, and the third average vector RVA. A (X+Y+Z)-dimensional vector in which the elements of the first average vector TVA, the second average vector CVA, and the third average vector RVA are arranged in order, i.e., [TV(1), TV(2), . . . , TV(X), CV(1), CV(2), . . . , CV(Y), RV(1), RV(2), . . . , RV(Z)], is created. The document comparison data DCdt contains one (X+Y+Z)-dimensional vector.

Creating the document comparison data DCdt from the first average vector TVA, the second average vector CVA, and the third average vector RVA can reduce the number of elements contained in the document comparison data DCdt. Thus, the amount of calculation can be small, and the time required for the processing can be shortened.

Specifically, the elements of the first to X-th dimensions of the vector contained in the document comparison data DCdt correspond to the elements of the first average vector TVA, and the elements of the (X+1)-th to (X+Y)-th dimensions thereof correspond to the elements of the second average vector CVA, and the elements of the (X+Y+1)-th to (X+Y+Z)-th dimensions thereof correspond to the elements of the third average vector RVA.

Note that the arrangement order of the first average vector TVA, the second average vector CVA, and the third average vector RVA is no particularly limited. The document comparison data DCdt may have a vector in which the elements of the second average vector CVA, the elements of the first average vector TVA, and the elements of the third average vector RVA are arranged in this order.

Although the document comparison data DCdt has a form of a vector in which the elements are arranged in the row direction (also referred to as a row vector) in the example shown in FIG. 13A, one embodiment of the present invention is not limited thereto. The document comparison data DCdt may have a form of a vector in which the elements are arranged in the column direction (also referred to as a column vector).

As shown in FIG. 13B and FIG. 13C, the document comparison data DCdt may have a matrix form in which the elements are arranged in the row direction and the column direction. FIG. 13B shows an example where the document comparison data DCdt has a matrix in which the elements of the first average vector TVA are arranged in the first row, the elements of the second average vector CVA are arranged in the second row, and the elements of the third average vector RVA are arranged in the third row. The arrangement order of the first average vector TVA, the second average vector CVA, and the third average vector RVA is not particularly limited. The document comparison data DCdt may have a matrix in which the elements of the second average vector CVA are arranged in the first row, the elements of the first average vector TVA are arranged in the second row, and the elements of the third average vector RVA are arranged in the third row.

Note that when the dimension number X, the dimension number Y, and the dimension number Z are different from one another, the document comparison data DCdt has a matrix of three rows and R columns. The number of columns R is an integer greater than or equal to the largest number among the dimension number X, the dimension number Y, and the dimension number Z. That is, the first average vector data TVAdt, the second average vector data CVAdt, and the third average vector data RVAdt are each extended to the R dimension, and zero is put in the extended region. Then, the extended first average vector data TVAdt, second average vector data CVAdt, and third average vector data RVAdt are put together, whereby the document comparison data DCdt of three rows and R columns can be created.

FIG. 13B shows an example where the document comparison data DCdt has a matrix in which the elements of the first average vector TVA are arranged in the first column, the elements of the second average vector CVA are arranged in the second column, and the elements of the third average vector RVA are arranged in the third column. The arrangement order of the first average vector TVA, the second average vector CVA, and the third average vector RVA is not particularly limited. The document comparison data DCdt may have a matrix in which the elements of the second average vector CVA are arranged in the first column, the elements of the first average vector TVA are arranged in the second column, and the elements of the third average vector RVA are arranged in the third column.

Note that when the dimension number X, the dimension number Y, and the dimension number Z are different from one another, the document comparison data DCdt has a matrix of R rows and three columns. The number of rows R is an integer greater than or equal to the largest number among the dimension number X, the dimension number Y, and the dimension number Z. That is, the first average vector data TVAdt, the second average vector data CVAdt, and the third average vector data RVAdt are each extended to the R dimension, and zero is put in the extended region. Then, the extended first average vector data TVAdt, second average vector data CVAdt, and third average vector data RVAdt are put together, whereby the document comparison data DCdt of R rows and three columns can be created.

Here, the case where the word data TWdt and the reference word data RWdt have no word in common is described.

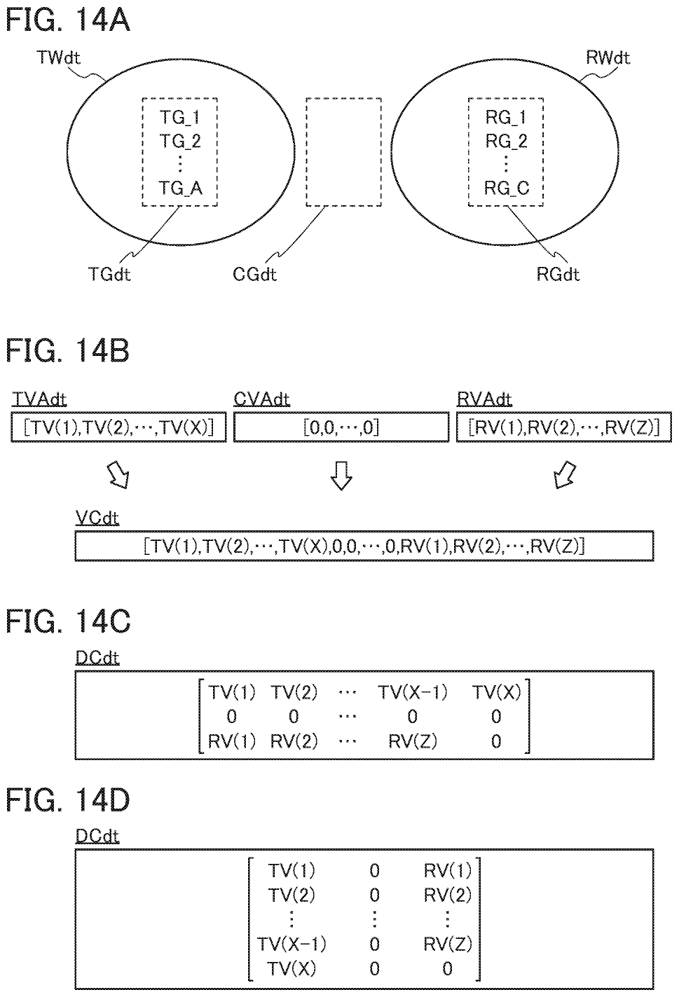

As shown in FIG. 14A, in the case where a word that is contained in the word data TWdt and also contained in the reference word data RWdt does not exist, there is no word contained in the second classification data CGdt. In the case where there is no word contained in the second classification data CGdt, all the elements of the second average vector CVA are set to zero, i.e., the second average vector CVA is set to Y-dimensional [0, 0, . . . , 0], as shown in FIG. 14B.

The document comparison data DCdt can have a vector form as shown in FIG. 14B. Alternatively, the document comparison data DCdt may have a matrix form as shown in FIG. 14C and FIG. 14D. The description of FIG. 13A to FIG. 13C can be referred to for the creation of the document comparison data DCdt; thus, the detailed description thereof is omitted.

Next, the case where there is no word that exists in only one of the word data TWdt and the reference word data RWdt is described.

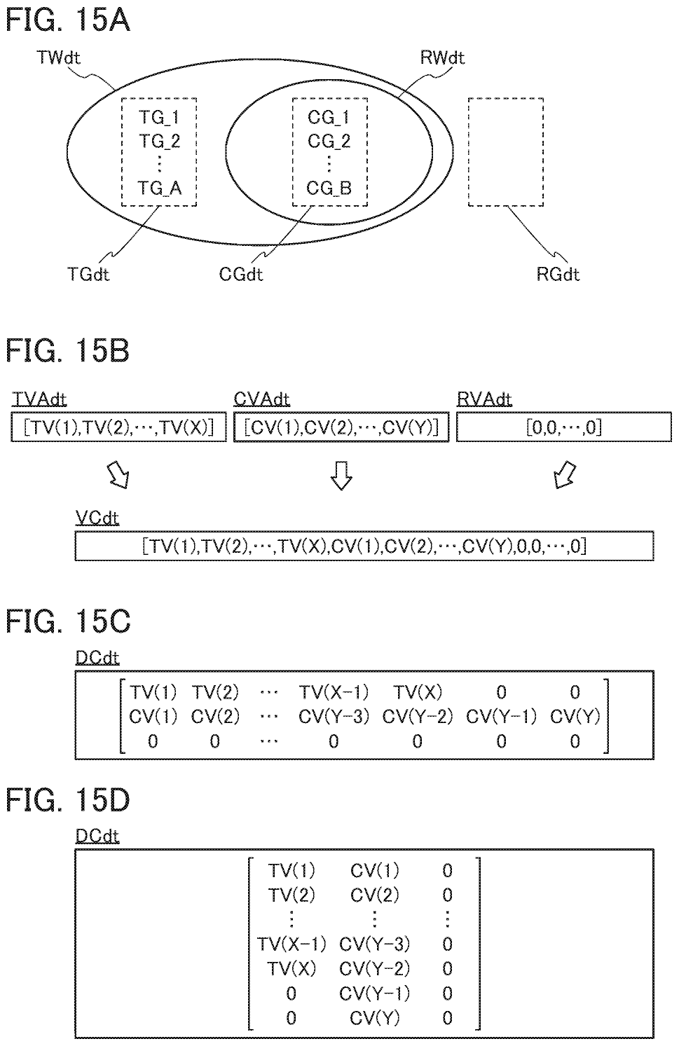

As shown in FIG. 15A, in the case where there is no word that is not contained in the word data TWdt but is contained in the reference word data RWdt, there is no word contained in the third classification data RGdt. In the case where there is no word contained in the third classification data RGdt, all the elements of the third average vector RVA are set to zero, i.e., the third average vector RVA is set to a Z-dimensional vector [0, 0, . . . , 0] as shown in FIG. 15B.

In the case where a word that is contained in the word data TWdt but not contained in the reference word data RWdt does not exist, there is no word contained in the first classification data TGdt. Also in this case, in the same manner, all the elements of the first average vector TVA are set to zero, i.e., the first average vector TVA is set to an X-dimensional vector [0, 0, . . . , 0].

The document comparison data DCdt can have a vector form as shown in FIG. 15B. Alternatively, the document comparison data DCdt may have a matrix form as shown in FIG. 15C and FIG. 15D. The description of FIG. 13A to FIG. 13C can be referred to for the creation of the document comparison data DCdt; thus, the detailed description thereof is omitted.

Note that also in the document classification method described in <Example 1-1 of document classification method>, in the case where there is no word contained in the first classification data TGdt, in the case where there is no word contained in the second classification data CGdt, or in the case where there is no word contained in the third classification data RGdt, the corresponding elements of the document comparison data DCdt shown in FIG. 6 are to zero.

### [Step S33]

Next, the category SE of the reference document data RD is determined from the document comparison data DCdt created in Step S32 using the classification model (Step S33 in FIG. 3). The above description can be referred to for Step S33; thus, the detailed description thereof is omitted.

Note that in the case where the document comparison data DCdt has a vector form shown in FIG. 13A or the like, the number of units of the input layer is (X+Y+Z). In the case where the document comparison data DCdt has a matrix form shown in FIG. 13B or the like, the number of units of the input layer is (3×R).

### [Step S41]

Next, the category SE determined in Step S33 is output to the output unit 140 (Step S41 in FIG. 3). The above description can be referred to for Step S41; thus, the detailed description thereof is omitted.

### Example 2 of Document Classification Method

Here, an example of comparing one piece of document data TD with a plurality of pieces of reference document data RD is described.

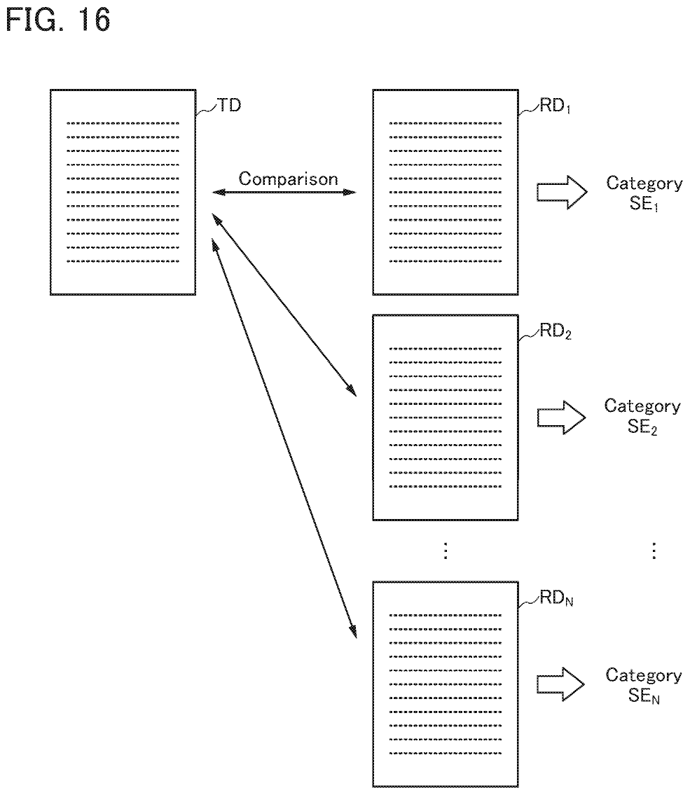

FIG. 16 shows an example of comparing one piece of document data TD with N pieces (N is an integer of 2 or more) of reference document data (first reference document data RD₁ to N-th reference document data RD_{N}). As shown in FIG. 16, a category SE₁ is determined by comparison between the document data TD and the first reference document data RD₁. Similarly, a category SE₂ is determined by comparison between the document data TD and the second reference document data RD₂, and a category SE_{N} is determined by comparison between the document data TD and the N-th reference document data RD_{N}.

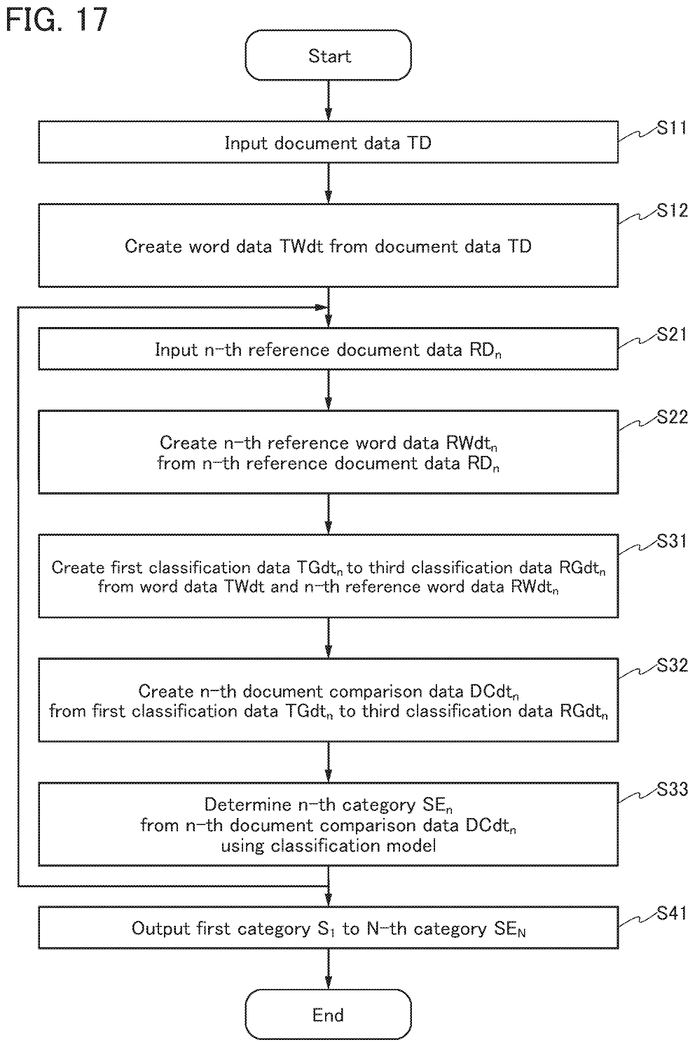

FIG. 17 shows a flowchart of the example of comparing one piece of document data TD with a plurality of pieces of reference document data RD.

### [Step S11 and Step S12]

First, in Step S11, the user inputs the document data TD to the input unit 110. Then, in Step S12, the processing unit 130 extracts words from the document data TD input in Step S11 and creates the word data TWdt. The description in <Example 1-1 of document classification method> can be referred to for Step S11 and Step S12; thus, the detailed description thereof is omitted.

Note that since the document data TD and the word data TWdt created from the document data TD are data common to the first reference document data RD₁ to the N-th reference document data RD_{N}, Step S11 and Step S12 are each performed once, and the word data TWdt created in Step S12 is stored in the processing unit 130 or the storage unit 120.

### [Step S21]

Next, in Step S21, the user inputs the n-th (n is an integer greater than or equal to 1 and less than or equal to N) reference document data RDₙ (Step S21 in FIG. 17). Although the n-th reference document data RDₙ is input after Step S12 in the example shown in FIG. 17, one embodiment of the present invention is not limited thereto. After the document data TD is input in Step S11, the first reference document data RD₁ to the N-th reference document data RD_{N} may be input sequentially. Alternatively, after the first reference document data RD₁ to the N-th reference document data RD_{N} are input sequentially in Step S11, the document data TD may be input.

### [Step S22]

Next, in Step S22, the processing unit 130 extracts words from the n-th reference document data RDₙ input in Step S21 and creates n-th reference word data RWdtₙ (Step S22 in FIG. 17). The description in <Example 1-1 of document classification method> can be referred to for Step S22; thus, the detailed description thereof is omitted.

### [Step S31]

Next, first classification data TGdtₙ, second classification data CGdtₙ, and third classification data RGdtₙ are created from the word data TWdt created in Step S12 and the n-th reference word data RWdtₙ created in Step S22 (Step S31 in FIG. 17). The description in <Example 1-1 of document classification method> can be referred to for Step S31; thus, the detailed description thereof is omitted.

### [Step S32]

Next, first vector data TVdtₙ, second vector data CVdtₙ, and third vector data RVdtₙ are created from the first classification data TGdtₙ, the second classification data CGdtₙ, and the third classification data RGdtₙ created in Step S31. Then, n-th document comparison data DCdtₙ is created from the first vector data TVdtₙ, the second vector data CVdtₙ, and the third vector data RVdtₙ (Step S32 in FIG. 17). The description in <Example 1-1 of document classification method> can be referred to for Step S32; thus, the detailed description thereof is omitted.

### [Step S33]

Next, a category SEₙ of the n-th reference document data RDₙ is determined from the n-th document comparison data DCdtₙ created in Step S32 using the classification model (Step S33 in FIG. 17). The description in <Example 1-1 of document classification method> can be referred to for Step S33; thus, the detailed description thereof is omitted.

Step S21 to Step S33 are performed repeatedly for the first reference document data RD₁ to the N-th reference document data RD_{N}.

### [Step S41]

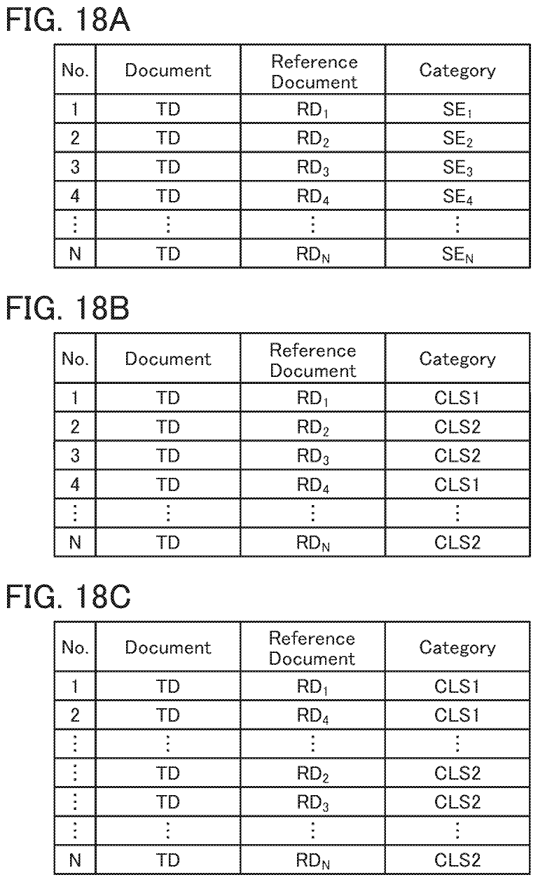

Next, the first category SE₁ to the N-th category SE_{N} determined in Step S33 are output to the output unit 140 (Step S41 in FIG. 17). FIG. 18A shows an example of the output. As shown in FIG. 18A, the output can be a list of the name of the document, the name of the reference document, and the category, for example. FIG. 18B shows an example of the results of two-level classification into the category CLS1 and the category CLS2. Since the category is determined by a combination of the document data TD and the reference document data RD, even the same document data TD can be classified into different categories depending on the reference document data RD as shown in FIG. 18B. Note that although FIG. 18A and FIG. 18B show the tables with the arrangement in the order of the reference documents, the arrangement order is not particularly limited. For example, as shown in FIG. 18C, the arrangement in the order of categories may be employed.

A document classification method different from the above-described one is described.

### Example 3 of Document Classification Method

Here, a document classification method in which reference document data is stored as a database in advance and the user inputs document data in use is described.

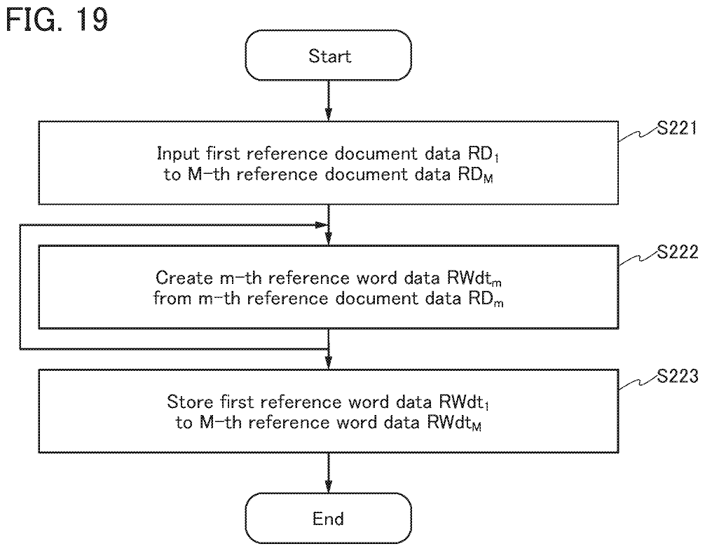

First, a method for creating a database from reference document data is described. FIG. 19 shows a flowchart of an example of the method for creating a database. Here, a method for creating a database from M pieces (M is an integer of 1 or more) of reference document data is described as an example.

### [Step S221]

First, the user inputs the first reference document data RD₁ to the M-th reference document data RD_{M}, to the input unit 110 (Step S221 in FIG. 19).

### [Step S222]

Next, the processing unit 130 extracts words from the m-th (m is an integer greater than or equal to 1 and less than or equal to M) reference document data RDₘ input in Step S221 and creates m-th reference word data RWdtₘ (Step S222 in FIG. 19).

Step S222 is performed repeatedly for the first reference document data RD₁ to the M-th reference document data RD_{M} to create first reference word data RWdt₁ to M-th reference word data RWdt_{M}.

### [Step S223]

Then, the first reference word data RWdt₁ to the M-th reference word data RWdt_{M} created in Step S223 are stored in the storage unit 120 (Step S223 in FIG. 19). The first reference word data RWdt₁ to the M-th reference word data RWdt_{M} are stored as a database. Note that the first reference document data RD₁ to the M-th reference document data RD_{M} may be stored in the database together with the first reference word data RWdt₁ to the M-th reference word data RWdt_{M}.

Next, a method for performing classification by inputting document data and comparing it with reference word data of reference document data stored in the database is described.

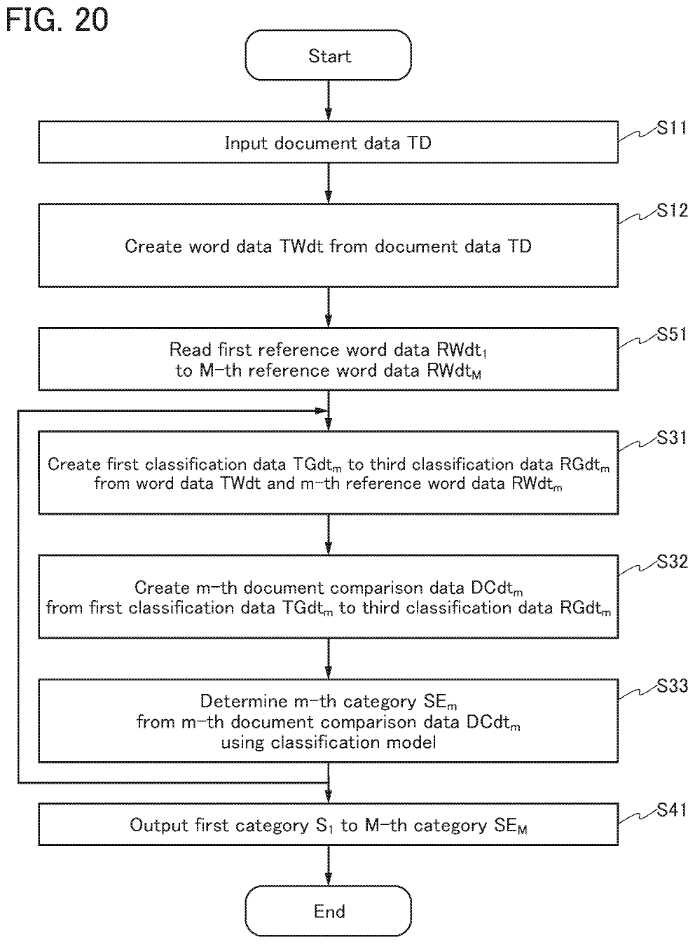

FIG. 20 shows a flowchart of an example of the classification method.

### [Step S11 and Step S12]

First, in Step S11, the user inputs the document data TD to the input unit 110 (Step S11 in FIG. 20). Then, in Step S12, the processing unit 130 extracts words from the document data TD input in Step S11 and creates the word data TWdt (Step S12 in FIG. 20). The description in <Example 2 of document classification method> can be referred to for Step S11 and Step S12; thus, the detailed description thereof is omitted.

### [Step S51]

Next, the reference word data stored in the database is read (Step S51 in FIG. 20). The user may designate a reference document to be subjected to comparison, from the database. In the example described here, the document data TD is compared with the first reference document data RD₁ to the M-th reference document data RD_{M}, and the first reference word data RWdt₁ to the M-th reference word data RWdt_{M} are read from the database.

### [Step S31 to Step S33]

Next, from the word data TWdt created in Step S12 and the m-th (m is an integer greater than or equal to 1 and less than or equal to M) reference word data RWdtₘ, m-th document comparison data DCdtₘ is created and the m-th category SEₘ is determined using the classification model (Step S31 to Step S33 in FIG. 20). The description in <Example 2 of document classification method> can be referred to for Step S31 to Step S33; thus, the detailed description thereof is omitted.

Step S31 to Step S33 are performed repeatedly for the first reference document data RD₁ to the M-th reference document data RD_{M}.

### [Step S41]

Next, the first category SE₁ to the M-th category SE_{M} determined in Step S33 are output to the output unit 140 (Step S41 in FIG. 20). The description in <Example 2 of document classification method> can be referred to for Step S41; thus, the detailed description thereof is omitted.

### Example 4 of Document Classification Method

A document and a reference document to be subjected to comparison may be designated from the reference word data stored in the database. In such a case, Step S11 and Step S12 are not performed in the flowchart shown in FIG. 20, and the user designates a document and a reference document and reads the corresponding reference word data from the database in Step S51. The description in <Example 3 of document classification method> can be referred to for Step S31 and the subsequent steps; thus, the detailed description thereof is omitted.

This embodiment can be combined with the other embodiments as appropriate. In this specification, in the case where a plurality of structure examples are shown in one embodiment, the structure examples can be combined as appropriate.

### Embodiment 2

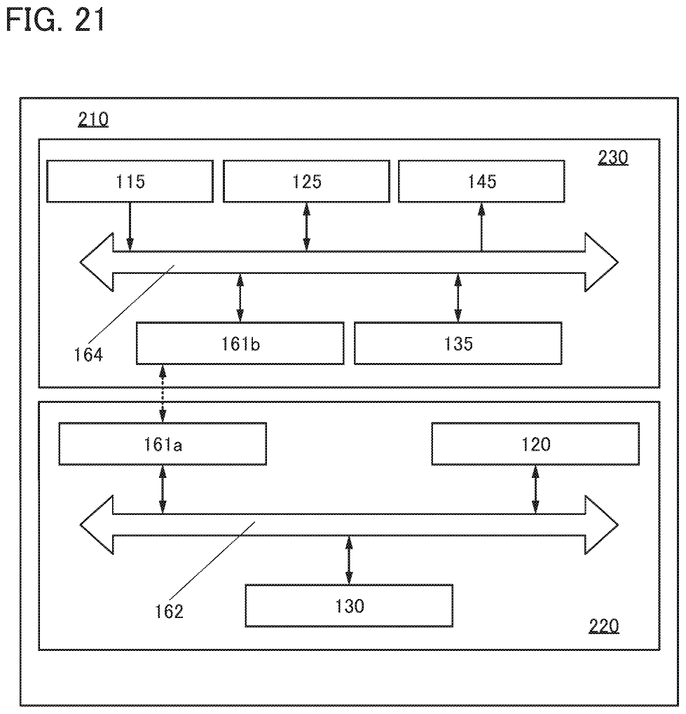

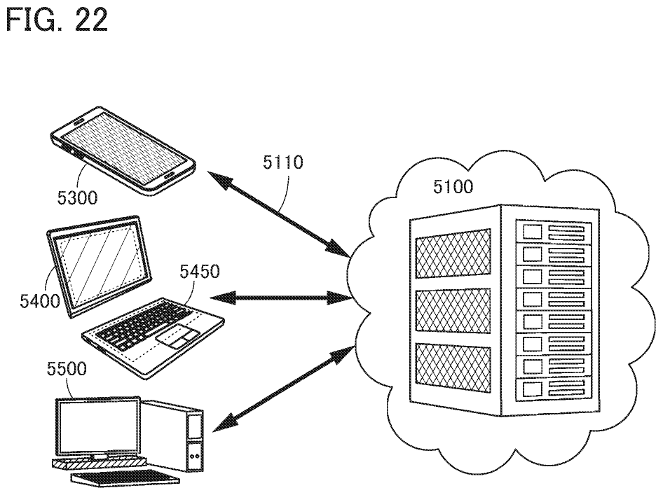

In this embodiment, a document classification system of one embodiment of the present invention is described with reference to FIG. 21 and FIG. 22.

### Structure Example 2 of Document Classification System

FIG. 21 shows a block diagram of a document classification system 210. The document classification system 210 includes a server 220 and a terminal 230 (e.g., a personal computer). Note that the description in <Structure example 1 of document classification system> in Embodiment 1 can be referred to for the same components as those in the document classification system 200 shown in FIG. 1.

The server 220 includes a communication unit 161a, a transmission path 162, the storage unit 120, and the processing unit 130. Although not shown in FIG. 21, the server 220 may further include at least one of an input unit, a database, an output unit, and an input unit.

The terminal 230 includes a communication unit 161b, a transmission path 164, an input unit 115, a storage unit 125, a processing unit 135, and a display unit 145. Examples of the terminal 230 include a tablet personal computer, a laptop personal computer, and various portable information terminals. The terminal 230 may be a desktop personal computer without the display unit 145 and may be connected to a monitor functioning as the display unit 145, or the like.

A user of the document classification system 210 inputs document data from the input unit 115 of the terminal 230 to the server 220. The document data is transmitted from the communication unit 161b to the communication unit 161a.

The document data received by the communication unit 161a is stored in a memory included in the processing unit 130 or the storage unit 120 via the transmission path 162. The document data may be supplied from the communication unit 161a to the processing unit 130 via an input unit (see the input unit 110 shown in FIG. 1).

Various kinds of processing described in Embodiment 1 are performed in the processing unit 130. These kinds of processing require high processing capacity, and thus are preferably performed in the processing unit 130 included in the server 220. The processing unit 130 preferably has higher processing capacity than the processing unit 135.

Processing results of the processing unit 130 are stored in the memory included in the processing unit 130 or the storage unit 120 via the transmission path 162. After that, the processing results are output from the server 220 to the display unit 145 of the terminal 230. The processing results are transmitted from the communication unit 161a to the communication unit 161b. On the basis of the processing results of the processing unit 130, various kinds of data contained in a database may be transmitted from the communication unit 161a to the communication unit 161b. The processing results may be supplied from the processing unit 130 to the communication unit 161a via an output unit (the output unit 140 shown in FIG. 1).

[Communication Unit 161a and Communication Unit 161b]

The server 220 and the terminal 230 can transmit and receive data with the use of the communication unit 161a and the communication unit 161b. As the communication unit 161a and the communication unit 161b, a hub, a router, or a modem can be used, for example. Data may be transmitted and received through wire communication or wireless communication (e.g., radio waves or infrared rays).

### [Transmission Path 162 and Transmission Path 164]

The transmission path 162 and the transmission path 164 have a function of transmitting data. The communication unit 161a, the storage unit 120, and the processing unit 130 can transmit and receive data via the transmission path 162. The communication unit 161b, the input unit 115, the storage unit 125, the processing unit 135, and the output unit 140 can transmit and receive data via the transmission path 164.

### [Input Unit 115]

The input unit 115 can be used when the user inputs document data or reference document data. The input unit 115 can be used when a user designates an application. For example, the input unit 115 can have a function of operating the terminal 230; specific examples thereof include a mouse, a keyboard, and a touch panel.

### [Storage Unit 125]

The storage unit 125 may store one or both of the reference document data and the data supplied from the server 220. The storage unit 125 may include at least part of the data that can be included in the storage unit 120.

### [Processing Unit 130 and Processing Unit 135]

The processing unit 135 has a function of performing arithmetic operation or the like with use of data supplied from the communication unit 161b, the storage unit 125, the input unit 115, and the like. The processing unit 135 may have a function of executing at least part of processing that can be performed by the processing unit 130.

Each of the processing unit 130 and the processing unit 135 can include one or both of a transistor including a metal oxide in its channel formation region (OS transistor) and a transistor including silicon in its channel formation region (Si transistor).

In this specification and the like, a transistor including an oxide semiconductor or a metal oxide in a channel formation region is referred to as an oxide semiconductor transistor or an OS transistor. A channel formation region of an OS transistor preferably includes a metal oxide.

In this specification and the like, a metal oxide is an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases. That is to say, in the case where a metal oxide has at least one of an amplifying function, a rectifying function, and a switching function, the metal oxide can be referred to as a metal oxide semiconductor, or OS for short.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), and tungsten (W), for example. Note that a combination of two or more of the above elements may be used as the element M. The element M is, for example, an element that has high bonding energy with oxygen. The element M is, for example, an element that has higher bonding energy with oxygen than indium. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The semiconductor layer may be a metal oxide that does not contain indium and contains zinc, a metal oxide that does not contain indium and contains gallium, a metal oxide that does not contain indium and contains tin, or the like, e.g., zinc tin oxide or gallium tin oxide.

The processing unit 130 preferably includes an OS transistor. The OS transistor has an extremely low off-state current; thus, with the use of the OS transistor as a switch for retaining electric charge (data) that has flowed into a capacitor functioning as a memory element, a long data retention period can be ensured. When at least one of a register and a cache memory included in the processing unit 130 has such a feature, the processing unit 130 can be operated only when needed, and otherwise can be off while data processed immediately before turning off the processing unit 130 is stored in the memory element. In other words, normally-off computing is possible and the power consumption of the document classification system can be reduced.

### [Display Unit 145]

The display unit 145 has a function of displaying an output result. Examples of the display unit 145 include a liquid crystal display device and a light-emitting display device. Examples of light-emitting elements that can be used in the light-emitting display device include an LED (Light Emitting Diode), an OLED (Organic LED), a QLED (Quantum-dot LED), and a semiconductor laser. It is also possible to use, as the display unit 145, a display device using a MEMS (Micro Electro Mechanical Systems) shutter element, an optical interference type MEMS element, or a display device using a display element employing a microcapsule method, an electrophoretic method, an electrowetting method, an Electronic Liquid Powder (registered trademark) method, or the like, for example.

FIG. 22 is a conceptual diagram of the document classification system of this embodiment.

The document classification system shown in FIG. 22 includes a server 5100 and terminals (also referred to as electronic devices). Communication between the server 5100 and each terminal is conducted via an Internet connection 5110.

The server 5100 is capable of performing arithmetic operation using data input from the terminal via the Internet connection 5110. The server 5100 is capable of transmitting an arithmetic operation result to the terminal via the Internet connection 5110. Accordingly, the burden of arithmetic operation on the terminal can be reduced.

In FIG. 22, an information terminal 5300, an information terminal 5400, and an information terminal 5500 are shown as the terminals. The information terminal 5300 is an example of a portable information terminal such as a smartphone. The information terminal 5400 is an example of a tablet terminal. When the information terminal 5400 is connected to a housing 5450 with a keyboard, the information terminal 5400 can be used as a notebook information terminal. The information terminal 5500 is an example of a desktop information terminal.

With such a structure, the user can access the server 5100 from the information terminal 5300, the information terminal 5400, the information terminal 5500, and the like. Then, through the communication via the Internet connection 5110, the user can receive a service offered by an administrator of the server 5100. Examples of the service include a service with the use of the document classification method of one embodiment of the present invention. In the service, artificial intelligence may be utilized in the server 5100.

This embodiment can be combined with the other embodiments as appropriate.

### EXAMPLE

In this example, the percentage of correct answers in document classification was evaluated using the document classification method described in Embodiment 1.

The classification of the document was set to two-level classification with “highly relevant” and “less relevant”. Learning was performed with 500 sets of teacher data, and the classification of the teacher data was also set to the two-level classification. Bag of Words was used for vectorization of words, and the first vector data TVdt, the second vector data CVdt, and the third vector data RVdt each had 200 dimensions. The vector form shown in FIG. 13A was employed for the document comparison data DCdt and the document comparison data DCdt had 600 dimensions. Ten times of trial were performed, and the number of pieces of test data per time was approximately 100. A fully connected neural network was used as the classification model. The number of middle layers (hidden layers) of the neural network was five, and the numbers of units in the layers were 100, 80, 60, 40, and 20 from the input layer side. The number of units of the output layer was two.

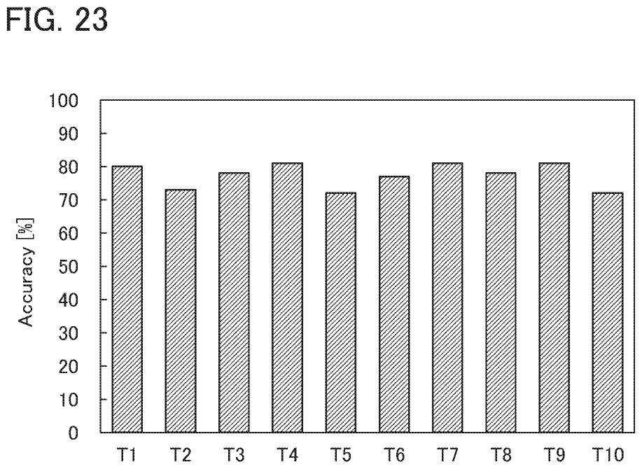

FIG. 23 shows the percentages of correct answers in the trials. In FIG. 23, the horizontal axis represents the trials (T1 to T10), and the vertical axis represents the percentage of correct answers (Accuracy). As shown in FIG. 23, it was found that the use of the document classification method of one embodiment of the present invention enabled document classification.

### REFERENCE NUMERALS

HL: middle layer, IL: input layer, NN: neural network, OL: output layer, 110: input unit, 115: input unit, 120: storage unit, 125: storage unit, 130: processing unit, 135: processing unit, 140: output unit, 145: display unit, 150: transmission path, 161a: communication unit, 161b: communication unit, 162: transmission path, 164: transmission path, 200: document classification system, 210: document classification system, 220: server, 230: terminal, 5100: server, 5110: Internet connection, 5300: information terminal, 5400: information terminal, 5450: housing, 5500: information terminal

1. A document classification system comprising an input unit, a storage unit, a processing unit, and an output unit,
wherein the input unit is configured to receive document data and reference document data,
wherein the storage unit is configured to store a classification model,
wherein the processing unit is configured to create first classification data, second classification data, and third classification data from the document data and the reference document data,
wherein a word contained in the document data and not contained in the reference document data belongs to the first classification data,
wherein a word contained in the document data and contained in the reference document data belongs to the second classification data,
wherein a word not contained in the document data and contained in the reference document data belongs to the third classification data,
wherein the processing unit is configured to create document comparison data from the first classification data, the second classification data, and the third classification data,
wherein the processing is configured to determine a category of the reference document data from the document comparison data using the classification model, and
wherein the output unit is configured to output the category.

2. A document classification system comprising an input unit, a storage unit, a processing unit, and an output unit,
wherein the input unit is configured to receive document data,
wherein the storage unit is configured to store reference document data and a classification model,
the processing unit is configured to create first classification data, second classification data, and third classification data from the document data and the reference document data,
wherein a word contained in the document data and not contained in the reference document data belongs to the first classification data,
wherein a word contained in the document data and contained in the reference document data belongs to the second classification data,
wherein a word not contained in the document data and contained in the reference document data belongs to the third classification data,
wherein the processing unit is configured to create document comparison data from the first classification data, the second classification data, and the third classification data,
wherein the processing unit is configured to determine a category of the reference document data from the document comparison data using the classification model, and
wherein the output unit is configured to output the category.

3. The document classification system according to claim 1,
wherein the processing unit is configured to create first vector data from the word belonging to the first classification data,
wherein the processing unit is configured to create second vector data from the word belonging to the second classification data,
wherein the processing unit is configured to create third vector data from the word belonging to the third classification data, and
wherein the processing unit is configured to create the document comparison data from the first vector data, the second vector data, and the third vector data.

4. The document classification system according to claim 1,
wherein the processing unit is configured to create first vector data from the word belonging to the first classification data and averaging elements of the first vector data to create first average vector data,
wherein the processing unit is configured to create second vector data from the word belonging to the second classification data and averaging elements of the second vector data to create second average vector data,
wherein the processing unit is configured to create third vector data from the word belonging to the third classification data and averaging elements of the third vector data to create third average vector data, and
wherein the processing unit is configured to create the document comparison data from the first average vector data, the second average vector data, and the third average vector data.

5. The document classification system according to claim 1,
wherein the classification model comprises a neural network, and
wherein the processing unit is configured to train the classification model with first document data, second document data, and a category as teacher data.

6. The document classification system according to claims 3,
wherein the classification model comprises a neural network, and
wherein the processing unit is configured to train the classification model with first document data, second document data, and a category as teacher data.

7. The document classification system according to claim 4,
wherein the classification model comprises a neural network, and
wherein the processing unit is configured to train the classification model with first document data, second document data, and a category as teacher data.

8. A document classification method comprising:
receiving document data and reference document data;
creating first classification data, second classification data, and third classification data from the document data and the reference document data;
creating document comparison data from the first classification data, the second classification data, and the third classification data;
determining a category of the reference document data from the document comparison data using a classification model; and
outputting the category,
wherein a word contained in the document data and not contained in the reference document data belongs to the first classification data,
wherein a word contained in the document data and contained in the reference document data belongs to the second classification data, and
wherein a word not contained in the document data and contained in the reference document data belongs to the third classification data.
